(19) United States
(12) Patent Application Publication
(10) Pub. No.: US 2026/0322169 A1
(43) Pub. Date: Oct. 15, 2026

(54) WIRELESS POWER CHARGING SYSTEM PERFORMING ASK MODULATION USING ACTIVE REACTANCE

(71) Applicant: Samsung Electronics Co., Ltd., Suwon-si (KR)

(72) Inventor: Hyun Su KIM, Suwon-si (KR)

(73) Assignee: Samsung Electronics Co., Ltd., Suwon-si (KR)

(21) Appl. No.: 19/398,597

(22) Filed: Nov. 24, 2025

(30) Foreign Application Priority Data
Apr. 15, 2025 (KR) 10-2025-0049035

(51) Int. Cl. H02J 50/12; H04L 27/08

(52) U.S. Cl. CPC H02J 50/12; H04L 27/08

(57) ABSTRACT

A receiver device of a wireless power charging system is provided. The receiver includes a receiver LC tank including a receiver load capacitor and a receiver coil, the receiver LC tank being configured to receive power induced from a transmitter device, a coil current sensor configured to sense a receiver coil current based on the power, a rectifier circuit configured to rectify receiver alternating current (AC) voltages provided from the receiver LC tank into a rectified voltage in response to rectified gate signals, and processing circuitry configured to generate the rectified gate signals by adjusting a phase difference between the receiver coil current and a differential signal between the receiver AC voltages according to a phase shift control signal and an ASK pattern signal, and output the rectified gate signals to the rectifier circuit.

### CROSS-REFERENCE TO RELATED APPLICATION

This application claims priority from Korean Patent Application No. 10-2025-0049035 filed on Apr. 15, 2025 in the Korean Intellectual Property Office, and all the benefits accruing therefrom under 35 U.S.C. 119, the contents of which in its entirety are herein incorporated by reference.

### BACKGROUND

### 1. Field

The present disclosure relates to amplitude shift keying (ASK) communication technology in a wireless power charging system.

### 2. Description of Related Art

With the development of information technology (IT), various types of electronic devices such as smartphones and tablet personal computers (PCs) have been widely distributed. It is common for such electronic devices to include a battery module for portability. Wireless charging technology for battery modules has been advancing, where, during wireless charging, information necessary (or otherwise, used) for power control is transmitted from a power receiver to a power transmitter using amplitude shift keying (ASK) communication.

Conventional wireless charging technology using ASK communication causes power loss during device charging, either due to the use of additional external capacitors or adjustments in the load current, and challenges have arisen in which the operation of a battery charging circuit is affected due to amplitude fluctuations in the receiver's rectified power supply.

### SUMMARY

The present disclosure provides a receiver device and a wireless power charging system having improved amplitude shift keying (ASK) communication efficiency by providing ASK communication from a power receiver to a power transmitter through dynamic reactance control.

Also, the present disclosure provides a receiver device and a wireless power charging system capable of reducing unnecessary power loss by providing ASK communication from a power receiver to a power transmitter through dynamic reactance control without additional external capacitors.

Objectives of the present disclosure are not limited to those mentioned above, and will be clearly understood by those skilled in the art based on the following description.

According to an aspect of the present disclosure, a receiver device includes a receiver LC tank including a receiver load capacitor and a receiver coil, the receiver LC tank being configured to receive power induced from a transmitter device, a coil current sensor configured to sense a receiver coil current based on the power, a rectifier circuit configured to rectify receiver alternating current (AC) voltages provided from the receiver LC tank into a rectified voltage in response to rectified gate signals, and processing circuitry configured to generate the rectified gate signals by adjusting a phase difference between the receiver coil current and a differential signal between the receiver AC voltages according to a phase shift control signal and an ASK pattern signal, and output the rectified gate signals to the rectifier circuit.

According to an aspect of the present disclosure, an operating method of a receiver device that receives power wirelessly from a transmitter device, includes generating coil sensing information by sensing a receiver coil current induced from the transmitter device through a receiver coil, detecting rising-edge zero points and falling-edge zero points of a signal based on the coil sensing information, selecting rising time delay information and falling time delay information from among a plurality of pieces of timing delay information based on an ASK pattern signal to obtain selected rising time delay information and selected falling time delay information, shifting the rising-edge zero points in a first direction by the selected rising time delay information in response to the ASK pattern signal being activated to obtain shifted rising-edge zero points, shifting the falling-edge zero points in the first direction by the selected falling time delay information in response to the ASK pattern signal being activated to obtain shifted falling-edge zero points, generating rectified gate signals for a rectifier circuit using the shifted rising-edge zero points and the shifted falling-edge zero points as gate-on/gate-off signals, and performing amplitude shift keying (ASK) modulation by adjusting a phase difference between the receiver coil current and a differential signal between receiver AC voltages based on the rectified gate signals.

According to an aspect of the present disclosure, a receiver device includes a coil current sensor configured to sense a current induced from a transmitter device through a receiver coil to obtain coil sensing information, a rectifier circuit configured to rectify receiver alternating current (AC) voltages generated based on the receiver coil into a rectified voltage in response to rectified gate signals, processing circuitry configured to generate the rectified gate signals based on the coil sensing information and the rectified voltage, and perform amplitude shift keying (ASK) modulation by adjusting a phase difference between a receiver coil current of the receiver coil and a differential signal between the receiver AC voltages, and a main low-dropout (LDO) regulator circuit configured to output power with noise removed from the rectified voltage.

According to an aspect of the present disclosure, a wireless power charging system includes a transmitter device and a receiver device, the receiver device including a receiver LC tank including a receiver load capacitor and a receiver coil, the receiver LC tank being configured to receive power induced from the transmitter device, a coil current sensor configured to sense a receiver coil current based on the power, a rectifier circuit configured to rectify receiver alternating current (AC) voltages provided from the receiver LC tank into a rectified voltage in response to rectified gate signals, and processing circuitry configured to generate the rectified gate signals by adjusting a phase difference between the receiver coil current and a differential signal between the receiver AC voltages according to a phase shift control signal and an ASK pattern signal, and output the rectified gate signals to the rectifier circuit

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing embodiments thereof in detail with reference to the attached drawings, in which:

FIG. 1 is a circuit diagram of a wireless power charging system according to embodiments of the present disclosure;

FIG. 2 is a diagram illustrating a controller depicted in FIG. 1;

FIG. 3 is a diagram illustrating a controller according to embodiments of the present disclosure;

FIG. 4 is a diagram illustrating a rectifying synchronization phase-shift controller depicted in FIG. 1;

FIG. 5 is a diagram illustrating a gate signal module depicted in FIG. 4;

FIG. 6 is a diagram illustrating a gate signal generator depicted in FIG. 5;

FIGS. 7 and 8 are timing diagrams for explaining amplitude shift keying (ASK) pattern signals during the operation of the wireless power charging system of FIG. 1;

FIG. 9 is a timing diagram for explaining embodiments of the operation of the wireless power charging system of FIG. 1;

FIG. 10 is a timing diagram for explaining embodiments of the operation of the wireless power charging system of FIG. 1;

FIG. 11 is a timing diagram for explaining embodiments of the operation of the wireless power charging system of FIG. 1;

FIG. 12 is a diagram illustrating the wireless power charging system of FIG. 1 as a time-domain wireless power transmission model;

FIG. 13 is a diagram illustrating the wireless power transmission model of FIG. 12 as a frequency domain;

FIGS. 14A, 14B and 14C illustrate a simplified receiver power transmission model in the wireless power transmission model of FIG. 12;

FIGS. 15A and 15B present graphs for explaining resistive rectification impedance in the wireless power transmission models of FIGS. 12 through 14C;

FIGS. 16A and 16B present graphs for explaining inductive rectification impedance using phase lead according to embodiments of the present disclosure in the wireless power transmission models of FIGS. 12 through 14C;

FIGS. 17A and 17B present graphs for explaining capacitive rectification impedance using phase lag according to embodiments of the present disclosure in the wireless power transmission models of FIGS. 12 through 14C;

FIGS. 18A, 18B and 18C illustrate a receiver power transmission model in a wireless power transmission model using external capacitors according to a comparative example;

FIGS. 19A, 19B and 19C illustrate a receiver power transmission model in a wireless power transmission model using phase shift according to embodiments of the present disclosure;

FIGS. 20A and 20B present graphs respectively showing the magnitudes of a rectified voltage, receiver AC voltages, and a receiver coil current in a receiver device when no phase shift is applied and when a phase lag is applied according to embodiments of the present disclosure;

FIG. 21 is a timing diagram for explaining embodiments of the operation of the wireless power charging system of FIG. 1;

FIGS. 22A, 22B and 22C explain a circuit diagram illustrating a simplified model of a receiver power system according to a load ASK communication method of a comparative example;

FIGS. 23A, 23B and 23C explain a circuit diagram illustrating a simplified model of a receiver power system according to the embodiment of FIG. 21;

FIGS. 24A, 24B and 24C explain a circuit diagram illustrating a simplified model of a transmitter power system according to a load ASK communication method of a comparative example;

FIGS. 25A, 25B and 25C present a circuit diagram illustrating a simplified model of a transmitter power system according to the embodiment of FIG. 21;

FIG. 26 is a voltage-current graph comparing and explaining the operations of the wireless power charging system according to the load ASK communication method of a comparative example and the wireless power charging system of FIG. 21;

FIG. 27 is a frequency-coil current graph comparing and explaining the operations of the wireless power charging system according to the load ASK communication method of a comparative example and the wireless power charging system of FIG. 21;

FIGS. 28A and 28B present graphs respectively showing the magnitudes of the rectified voltage, receiver AC voltages, and receiver coil current in the receiver device when no phase shift is applied and when a phase lead shift is applied according to embodiments of the present disclosure;

FIG. 29 is a circuit diagram of a wireless power charging system according to embodiments of the present disclosure;

FIGS. 30A, 30B and 30C illustrate a receiver power transmission model in the frequency domain of a receiver device in FIG. 29;

FIGS. 31A, 31B and 31C illustrate a transmitter power transmission model in the frequency domain of a transmitter device in FIG. 29;

FIG. 32 is a graph showing the magnitudes of a rectified voltage and a transmitter coil current in the wireless power charging system of FIG. 29 for a phase lag of θ°;

FIG. 33 is a timing diagram for explaining the operation of the wireless power charging system of FIG. 29;

FIG. 34 is a circuit diagram of a wireless power charging system according to embodiments of the present disclosure; and

FIG. 35 is a circuit diagram of a wireless power charging system according to embodiments of the present disclosure.

### DETAILED DESCRIPTION

Embodiments of the present disclosure will be described with reference to the attached drawings.

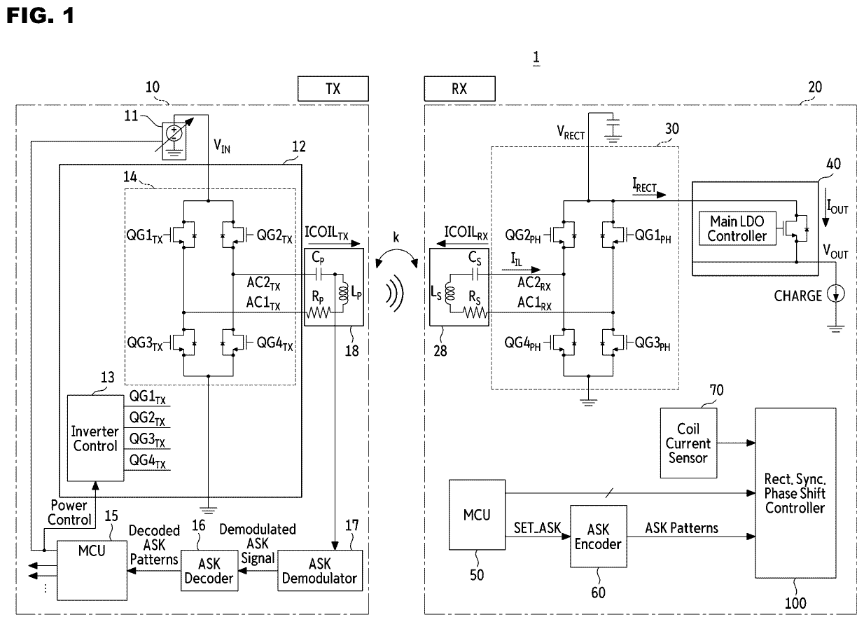

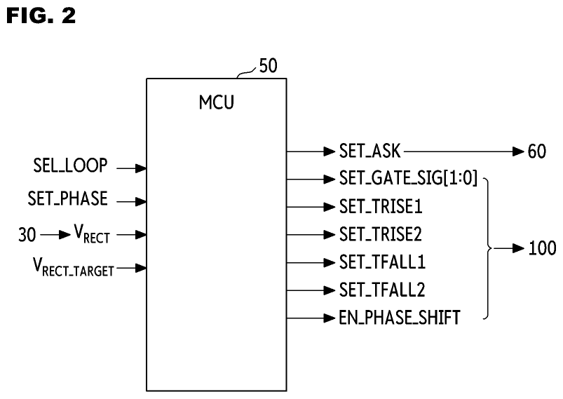

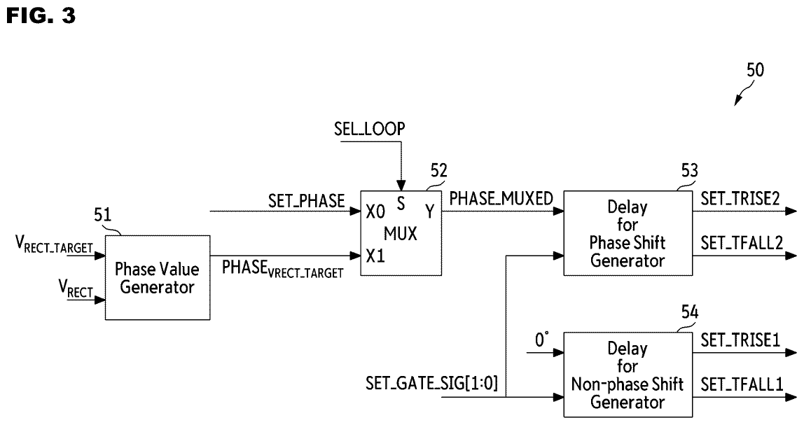

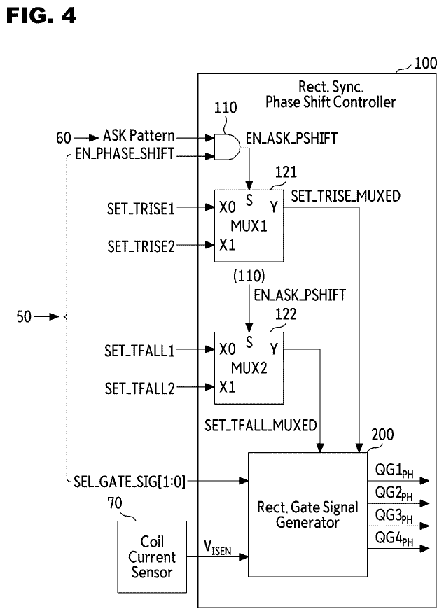

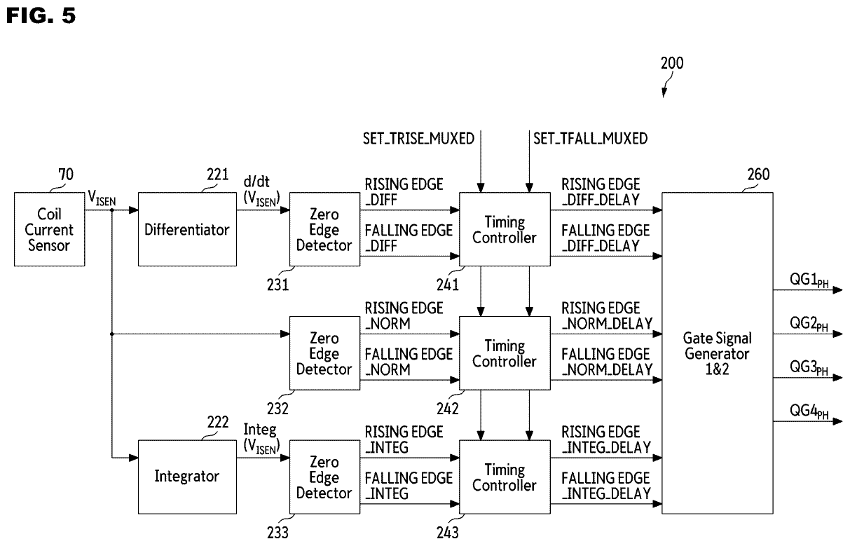

FIG. 1 is a circuit diagram of a wireless power charging system according to embodiments of the present disclosure. FIG. 2 is a diagram illustrating a controller depicted in FIG. 1. FIG. 3 is a diagram specifically illustrating the controller according to embodiments of the present disclosure. FIG. 4 is a diagram illustrating a rectifying synchronization phase-shift controller depicted in FIG. 1. FIG. 5 is a diagram illustrating a gate signal module depicted in FIG. 4. FIG. 6 is a diagram illustrating a gate signal generator depicted in FIG. 5.

Referring to FIGS. 1 through 6, a wireless power charging system 1 includes a transmitter (TX) device 10 and a receiver (RX) device 20 that wirelessly transmit power to and receive power from each other.

The TX device 10 includes an input power supply 11, an inverter 12, a TX main control unit (MCU) 15, an amplitude shift keying (ASK) decoder 16, an ASK demodulator 17, and/or a TX LC tank 18. The input power supply 11 supplies an input power V_{IN} to be transmitted from the TX device 10 to the RX device 20. The inverter 12 includes an inverter controller 13 and/or a TX bridge circuit 14. The inverter controller 13 generates gate signals QG1_{TX}, QG2_{TX}, QG3_{TX}, and QG4_{TX}. The TX bridge circuit 14 is connected between the input power supply 11 and a ground terminal, includes four switching transistors that are turned on and off by the gate signals QG1_{TX}, QG2_{TX}, QG3_{TX}, and QG4_{TX}, and generates a transmission voltage.

The TX bridge circuit 14 generates TX AC voltages AC1_{TX} and AC2_{TX} by complementarily switching a plurality of switches therein based on the gate signals QG1_{TX}, QG2_{TX}, QG3_{TX}, and QG4_{TX}. The complementarily switched TX AC voltages AC1_{TX} and AC2_{TX} provide AC power to the TX LC tank 18, and transmit wireless power charging to the RX device 20. The TX LC tank 18 includes a TX load capacitor C_{P} and/or a TX coil, which is represented by a TX inductor LP and a TX parasitic resistor RP.

The ASK demodulator 17 may generate a demodulated ASK signal that exhibits ASK depth, based on a TX coil current ICOIL_{TX}. The ASK decoder 16 may generate a decoded ASK pattern based on the demodulated ASK signal. For example, when the demodulated ASK signal increases above a predetermined (or alternatively, given) level, the decoded ASK pattern may be expressed as high, and when the demodulated ASK signal decreases below the predetermined (or alternatively, given) level, the decoded ASK pattern may be expressed as low, thereby demodulating the ASK pattern of the RX device 20.

The RX device 20 includes an RX LC tank 28, a rectifier circuit 30, a main low-dropout regulator (LDO) circuit 40, an RX MCU 50, an ASK encoder 60, a coil current sensor 70, a rectifying synchronization phase-shift controller 100, and/or a battery CHARGE.

The RX LC tank 28 receives wireless power charging from the TX device 10. The RX LC tank 28 includes an RX load capacitor Cs and/or an RX coil, which is represented by an RX inductor L_{S} and an RX parasitic resistor R_{S}.

The rectifier circuit 30 rectifies RX AC voltages AC1_{RX} and AC2_{RX} from the RX LC tank 28 into rectified power V_{RECT}. In embodiments, the rectifier circuit 30 includes a plurality of switches connected in a bridge form that receive the RX AC voltages AC1_{RX} and AC2_{RX} as inputs, and the plurality of switches are complementarily switched by rectifier gate signals QG1_{PH}, QG2_{PH}, QG3_{PH}, and QG4_{PH}, thereby generating a rectified voltage V_{RECT} and a rectified current I_{RECT}. The plurality of switches included in the rectifier circuit 30 may be connected in the same configuration as (or a similar configuration to) those in the TX bridge circuit 14.

For example, the rectifier circuit 30 includes a first path that includes first and third switches connected in series, and a second path that includes second and fourth switches connected in series, and the first and second paths are connected in parallel between an output node and a ground node. The common node of the first and third switches in the first path receives the first AC voltage AC1_{RX}, and the common node of the second and fourth switches in the second path receives the second AC voltage AC2_{RX}. The first, second, third, and fourth switches are switched by first, second, third, and fourth rectified gate signals QG1_{PH}, QG2_{PH}, QG3_{PH}, and QG4_{PH}, respectively. For example, the first and fourth switches are complementarily switched with the second and third switches.

The main LDO 40 removes noise from the rectified power V_{RECT} and supplies the noise-removed rectified power V_{RECT} as stable supply power to the battery CHARGE.

The coil current sensor 70 senses an RX coil current ICOIL_{RX} (may also be referred to herein as the RX coil current I_{RL}) generated from wireless power charging received from the RX LC tank 28, and provides coil sensing information (V_{ISEN} and I_{ISEN}) to the rectifying synchronization phase-shift controller 100.

The RX MCU 50 generates a plurality of control signals based on the rectified power V_{RECT} received from the rectifier circuit 30 and setting signals (SEL_LOOP, SET_PHASE, V_{RECT_TARGET}, and SET_GATE_SIG[1:0]) provided by firmware. For example, the RX MCU 50 provides an ASK activation signal SET_ASK to the ASK encoder 60. The RX MCU 50 also provides a gate-signal-control signal SET_GATE_SIG[1:0], time delay information (SET_TRISE1, SET_TRISE2, SET_TFALL1, and SET_FALL2), and a phase shift control signal EN_PHASE_SHIFT to the rectifying synchronization phase-shift controller 100.

In embodiments, the RX MCU 50 may be implemented to include a phase value generator 51, a setting value selector 52, a first phase shift delay value generator 53, and/or a second phase shift delay value generator 54.

In embodiments, the RX MCU 50 may receive the setting signals output from the firmware based on the state of the RX device 20 or user settings. The setting signals from the firmware may include, for example, a delay value selection signal SEL_LOOP, a phase setting value SET_PHASE, a target rectified voltage V_{RECT_TARGET}, and the gate-signal-control signal SET_GATE_SIG[1:0].

The phase value generator 51 compares the rectified voltage V_{RECT} with the target rectified voltage V_{RECT_TARGET}, calculates a phase value to bring the rectified voltage V_{RECT} to the target rectified voltage V_{RECT_TARGET}, and outputs the calculated phase value as a target phase shift value PHASE_{VRECT_TARGET}.

The setting value selector 52 selects either the phase setting value SET_PHASE or the target phase shift value PHASE_{VRECT_TARGET} based on the delay value selection signal SEL_LOOP and outputs the selected value as a phase selection value PHASE_MUXED.

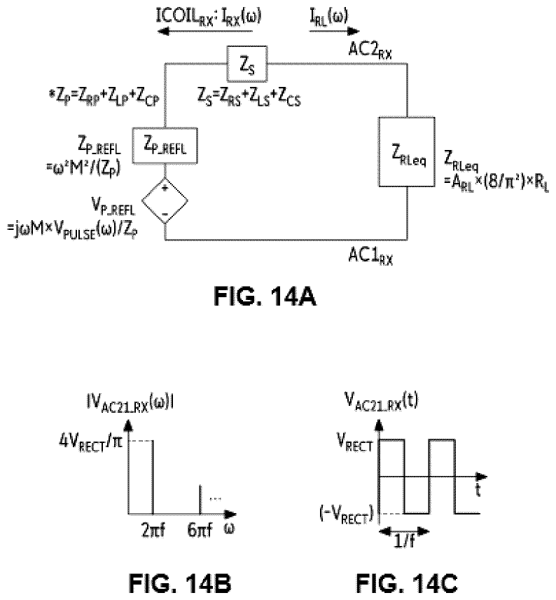

The first phase shift delay value generator 53 adjusts the phase selection value PHASE_MUXED according to the gate-signal-control signal SET_GATE_SIG[1:0] and outputs the adjusted value as second-type time delay information (SET_TRISE2 and SET_TFALL2) to the rectifying synchronization phase-shift controller 100. The gate-signal-control signal SET_GATE_SIG[1:0] is a signal that selects a first path through a differentiator 221, a second path with no differentiator or integrator, or a third path through an integrator 222, as depicted in FIGS. 14A, 14B and 14C.

For example, if the gate-signal-control signal SET_GATE_SIG[1:0] selects the first path, the first phase shift delay value generator 53 adjusts the phase selection value PHASE_MUXED using the differentiator 221, thereby generating and outputting first second-type time delay information (SET_TRISE2a and SET_TFALL2a). If the gate-signal-control signal SET_GATE_SIG[1:0] selects the second path, the first phase shift delay value generator 53 adjusts the phase selection value PHASE_MUXED, thereby generating and outputting second second-type time delay information (SET_TRISE2b and SET_TFALL2b). If the gate-signal-control signal SET_GATE_SIG[1:0] selects the third path, the first phase shift delay value generator 53 adjusts the phase selection value PHASE_MUXED using the integrator 222, thereby generating and outputting third second-type time delay information (SET_TRISE2c and SET_TFALL2c).

The first second-type time delay information (SET_TRISE2a and SET_TFALL2a), the second second-type time delay information (SET_TRISE2b and SET_TFALL2b), and the third second-type time delay information (SET_TRISE2c and SET_TFALL2c) may have different values, as depicted in FIGS. 16A through 18C.

The second phase shift delay value generator 54 outputs first-type time delay information (SET_TRISE1 and SET_TFALL1) to the rectifying synchronization phase-shift controller 100 according to the gate-signal-control signal SET_GATE_SIG[1:0].

For example, if the gate-signal-control signal SET_GATE_SIG[1:0] selects the first path, the second phase shift delay value generator 54 generates and outputs first first-type time delay information (SET_TRISE1a and SET_TFALL1a). If the gate-signal-control signal SET_GATE_SIG[1:0] selects the second path, the second phase shift delay value generator 54 generates and outputs, through adjustment, second first-type time delay information (SET_TRISE1b and SET_TFALL1b). If the gate-signal-control signal SET_GATE_SIG[1:0] selects the third path, the second phase shift delay value generator 54 generates and outputs third first-type time delay information (SET_TRISE1c and SET_TFALL1c).

The first first-type time delay information (SET_TRISE1a and SET_TFALL1a), the second first-type time delay information (SET_TRISE1b and SET_TFALL1b), and the third first-type time delay information (SET_TRISE1c and SET_TFALL1c) may have different values, as depicted in FIGS. 16A through 18C.

In embodiments, the RX MCU 50 may output time delay information (SET_TRISE2 and SET_TFALL2) set to a first setting value based on a phase setting value SET_PHASE output according to the delay value selection signal SEL_LOOP, such that a phase shift by θ° is performed, allowing the rectified gate signal generator 200 to generate phase-shifted first, second, third, and fourth rectified gate signals QG1_{PH}, QG2_{PH}, QG3_{PH}, and QG4_{PH} corresponding to the first setting value. In this case, the phase shift of θ° may result in a change in resonance characteristics due to a dynamic reactance change caused by a phase lag or phase lead operation, thereby enabling ASK modulation between the RX device 20 and the TX device 10.

In embodiments, the RX MCU 50 may output time delay information (SET_TRISE2 and SET_TFALL2) set to a second setting value based on a target phase shift value PHASE_{VRECT_TARGET} output according to the delay value selection signal SEL_LOOP, such that the rectified voltage V_{RECT} gradually becomes the target rectified voltage V_{RECT_TARGET}, allowing the rectified gate signal generator 200 to generate phase-shifted first, second, third, and fourth rectified gate signals QG1_{PH}, QG2_{PH}, QG3_{PH}, and QG4_{PH} corresponding to the second setting value. In this case, unlike the first setting value that is fixed by the phase setting value SET_PHASE, the second setting value may gradually change until the rectified voltage V_{RECT} approaches the target rectified voltage V_{RECT_TARGET}.

The rectifying synchronization phase-shift controller 100 includes an AND logic circuit 110, a first multiplexer 121, a second multiplexer 122, and/or a rectified gate signal generator 200. The AND logic circuit 110 performs an AND operation on an ASK pattern signal “ASK Pattern” generated from the ASK encoder 60 and a phase shift control signal EN_PHASE_SHIFT received from the RX MCU 50, thereby generating an ASK phase shift control signal EN_ASK_PSHIFT. Although an AND circuit is illustrated by way of example, other circuits capable of generating the ASK phase shift control signal EN_ASK_PSHIFT to enable the use of the ASK pattern signal “ASK Pattern” when the phase shift control signal EN_PHASE_SHIFT is activated, as shown in FIG. 8, may also be used.

When the ASK phase shift control signal EN_ASK_PSHIFT is activated, the first and second multiplexers 121 and 122 provide time delay information (SET_TRISE1, SET_TRISE2, SET_TFALL1, and SET_FALL2) to the rectified gate signal generator 200.

For example, when the ASK phase shift control signal EN_ASK_PSHIFT is deactivated, the first multiplexer 121 selects and outputs first rising time delay information SET_TRISE1, and when the ASK phase shift control signal EN_ASK_PSHIFT is activated, the first multiplexer 121 selects and outputs second rising time delay information SET_TRISE2 as rising time delay information SET_TRISE_MUXED.

For example, when the ASK phase shift control signal EN_ASK_PSHIFT is deactivated, the second multiplexer 122 selects and outputs first falling time delay information SET_TFALL1, and when the ASK phase shift control signal EN_ASK_PSHIFT is activated, the second multiplexer 122 selects and outputs second falling time delay information SET_TFALL2 as falling time delay information SET_TFALL_MUXED.

When the ASK phase shift control signal EN_ASK_PSHIFT is deactivated (0), the rectified gate signal generator 200 generates the first, second, third, and fourth rectified gate signals QG1_{PH}, QG2_{PH}, QG3_{PH}, and QG4_{PH} such that a differential signal (AC2_{RX}−AC1_{RX}) between the RX AC voltages AC1_{RX} and AC2_{RX} has the same phase as (or a similar phase to) an RX coil current I_{RL} based on the coil current sensor 70. That is, the rectified gate signal generator 200 generates and outputs rectified gate signals QG1_{PH}, QG2_{PH}, QG3_{PH}, and QG4_{PH} in which the phase shift between the differential signal (AC2_{RX}−AC1_{RX}) and the RX coil current I_{RL} is 0°.

When the ASK phase shift control signal EN_ASK_PSHIFT is activated (1), the rectified gate signal generator 200 performs an ASK phase shift, and generates and outputs the first, second, third, and fourth rectified gate signals QG1_{PH}, QG2_{PH}, QG3_{PH}, and QG4_{PH} such that the phase of the differential signal (AC2_{RX}−AC1_{RX}) is shifted by θ° relative to the RX coil current I_{RL}. In this specification, if the phase of the differential signal (AC2_{RX}−AC1_{RX}) is delayed by θ° relative to the RX coil current I_{RL}, it is referred to as a phase lag, and if the phase of the differential signal (AC2_{RX}−AC1_{RX}) is led by θ° relative to the RX coil current I_{RL}, it is referred to as a phase lead.

For example, when the ASK phase shift control signal EN_ASK_PSHIFT is deactivated (0), the rectified gate signal generator 200 generates and outputs the first, second, third, and fourth rectified gate signals QG1_{PH}, QG2_{PH}, QG3_{PH}, and QG4_{PH} such that the differential signal (AC2_{RX}−AC1_{RX}) and the RX coil current I_{RL} have the same phase (or similar phases), based on the rising time delay information SET_TRISE_MUXED and falling time delay information SET_TFALL_MUXED selected by the deactivated ASK phase shift control signal EN_ASK_PSHIFT, and the coil current sensing voltage V_{ISEN} (e.g., among the coil sensing information).

For example, when the ASK phase shift control signal EN_ASK_PSHIFT is activated (1), the rectified gate signal generator 200 generates and outputs the first, second, third, and fourth rectified gate signals QG1_{PH}, QG2_{PH}, QG3_{PH}, and QG4_{PH} such that the phase of the differential signal (AC2_{RX}−AC1_{RX}) is shifted by θ° relative to the RX coil current I_{RL}, based on the rising time delay information SET_TRISE_MUXED and falling time delay information SET_TFALL_MUXED selected by the activated ASK phase shift control signal EN_ASK_PSHIFT, and the coil current sensing voltage V_{ISEN} (e.g., among the coil sensing information).

The coil current sensor 70 may sense a measurement from the coil of the RX LC tank 28 as a current I_{COIL_SEN} or I_{SEN} or as a voltage V_{SEN} (may also be referred to herein as V_{ISEN}), or the sensed measurement may be current data digitalized by an analog-to-digital converter (ADC), or may include other types of information capable of representing coil sensing information. According to embodiments, the coil current sensing voltage V_{ISEN} may be the voltage measured across the coil of the RX LC tank 28. The RX coil current I_{RL} will hereinafter be referred to as current information I_{ISEN} sensed by the coil current sensor 70.

The rectified gate signal generator 200 may be implemented to include, as illustrated in FIG. 5, a differentiator 221, an integrator 222, a plurality of zero-edge detectors 231, 232, and 233, a plurality of timing controllers 241, 242, and 243, and a gate signal generator 260.

In embodiments, the zero-edge detectors 231, 232, and 233 may generate short pulse signals at the point where the signals of each path reach 0 V due to a rising edge or a falling edge. Rising- and falling-edge zero points may alternatively be represented by other types of signals that can express such zero-edge information.

For example, the zero-edge detector 231 may detect rising-edge zero points RISING EDGE_DIFF and falling-edge zero points FALLING EDGE_DIFF of a differentiated signal d/dt(V_{ISEN}) of coil sensing information V_{ISEN} output from the differentiator 221 based on the coil sensing information V_{ISEN} output from the coil current sensor 70. For example, the zero-edge detector 232 may detect rising-edge zero points RISING EDGE_NORM and falling-edge zero points FALLING EDGE_NORM of the coil sensing information V_{ISEN}, output from the coil current sensor 70. For example, the zero-edge detector 233 may detect rising-edge zero points RISING EDGE_INTEG and falling-edge zero points FALLING EDGE_INTEG of an integrated signal Integ(V_{ISEN}) of the coil sensing information V_{ISEN}, output from the integrator 222.

In embodiments, the timing controllers 241, 242, and 243 may delay the signals output from the zero-edge detectors 231, 232, and 233 by an amount corresponding to the selected rising time delay information SET_TRISE_MUXED determined by the ASK phase shift control signal EN_ASK_PSHIFT, and output the delayed signals. Alternatively, the timing controllers 241, 242, and 243 may delay the signals output from the zero-edge detectors 231, 232, and 233 by an amount corresponding to the selected falling time delay information SET_TFALL_MUXED determined by the ASK phase shift control signal EN_ASK_PSHIFT, and output the delayed signals.

Referring to FIG. 6, the gate signal generator 260 includes a first gate signal generator 260A and/or a second gate signal generator 260B.

The first gate signal generator 260A includes a third multiplexer 261 and/or a first gate signal generator 262. The second gate signal generator 260B includes a fourth multiplexer 263 and/or a second gate signal generator 264. When falling-edge delays FALLING EDGE_DIFF_DELAY, FALLING EDGE_NORM_DELAY, and FALLING EDGE_INTEG_DELAY and rising-edge delays RISING EDGE_DIFF_DELAY, RISING EDGE_NORM_DELAY, and RISING EDGE_INTEG_DELAY output from the zero-edge detectors 231, 232, and 233 are received, the third and fourth multiplexers 261 and 263 output falling-edge delays and rising-edge delays, selected according to the gate-signal-control signal SET_GATE_SIG[1:0], as gate-on signals GATE_ON1 and GATE_ON3 and gate-off signals GATE_OFF2 and GATE_OFF4, respectively. The gate signal generator 262 generates first and fourth rectified gate signals QG1_{PH} and QG4_{PH} based on the gate-on signal GATE_ON1 and the gate-off signal GATE_OFF2. The gate signal generator 264 generates second and third rectified gate signals QG2_{PH} and QG3_{PH} based on the gate-on signal GATE_ON3 and the gate-off signal GATE_OFF4.

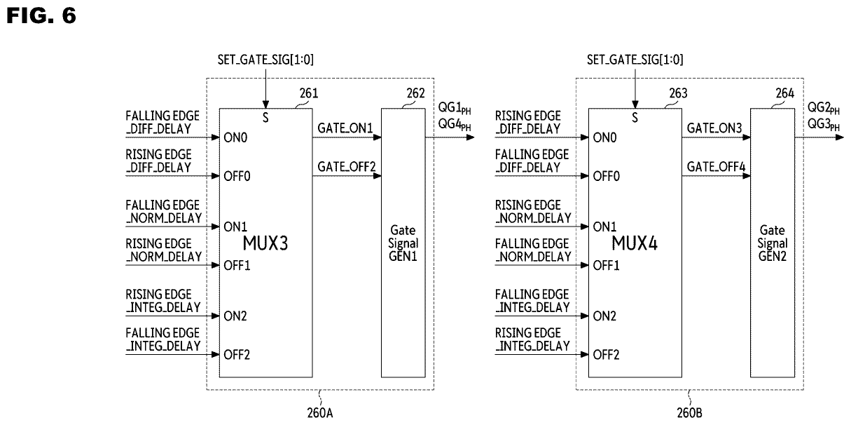

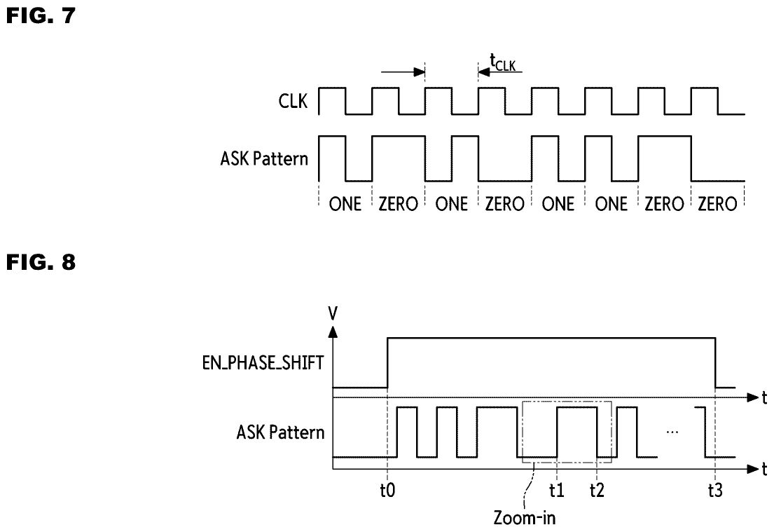

The configuration and operation of the rectified gate signal generator 200 will hereinafter be described in further detail with reference to FIG. 7 and subsequent figures.

FIGS. 7 and 8 are timing diagrams for explaining an ASK pattern signal during the operation of the wireless power charging system of FIG. 1.

In embodiments, the RX device 20 may generate ASK communication format data based on a level difference between rectified power V_{RECT} provided from the TX device 10 and target rectified power V_{RECT_TARGET} during wireless charging, or based on other data to be sent to the TX device 10. For example, referring to FIG. 7, the RX device 20 may generate data to be transmitted to the TX device 10 as an ASK pattern signal “ASK Pattern”, e.g., bi-phase data, in synchronization with an operation clock CLK.

When the ASK pattern signal “ASK Pattern” is high, the RX device 20 changes the resonance characteristics of the wireless power charging system 1, thereby causing amplitude changes in the RX coil current ICOIL_{RX} of the RX device 20 and the TX coil current ICOIL_{TX} of the TX device 10. When the ASK pattern signal “ASK Pattern” is low, the RX device 20 returns the resonance characteristics of the wireless power charging system 1 to a preset (or alternatively, given) state, thereby causing amplitude changes again in the RX coil current ICOIL_{RX} and the TX coil current ICOIL_{TX} compared to when the ASK pattern signal “ASK Pattern” is high. In this manner, when the RX device 20 operates in bi-phase according to the ASK pattern signal “ASK Pattern”, the amplitude changes appear with the same pattern at the TX device 10, allowing the TX device 10 to demodulate signals transmitted to the RX device 20. According to embodiments, the ASK pattern signal may represent a data signal to be communicated to the TX device 10. For example, the ASK pattern signal may include information regarding a current voltage of the battery CHARGE, a request for a software update, etc. According to embodiments, the RX device 20 performs ASK modulation of the resonance characteristics of the wireless power charging system based on a phase shift as discussed further herein. The TX device 10 may demodulate the ASK modulation of the resonance characteristics to obtain the data signal represented by the ASK pattern signal. According to embodiments, the TX device 10 may perform further operations based on the data signal. For example, the TX device 10 may change an amount of power induced in the RX device 20 (e.g., increase power, decrease power, stop charging, start charging, etc.).

In embodiments, the ASK pattern signal “ASK Pattern” may be a pattern signal indicating whether a pole transition occurs within a preset (or alternatively, given) operation cycle or at a preset (or alternatively, given) timing, and does not necessarily refer to the high/low pattern of a specific signal level itself.

Referring to FIG. 8, when the RX device 20 decides (or is triggered) to transmit ASK communication to the TX device 10, the RX MCU 50 outputs a phase shift control signal EN_PHASE_SHIFT at an active level during the period from t0 to t3, and outputs an ASK activation signal SET_ASK to the ASK encoder 60. The ASK encoder 60 may generate and output an ASK pattern signal “ASK Pattern” during the period from t0 to t3 according to the ASK activation signal SET_ASK.

For the understanding of the ASK communication operation of the RX device 20, the operation during a section of the ASK pattern signal “ASK Pattern” in FIG. 8, particularly, a zoom-in period “Zoom-in,” in which the ASK pattern signal “ASK Pattern” becomes high (for example, from t1 to t2), will hereinafter be described with reference to FIGS. 9 through 11. It is apparent that the operation scheme to be described in FIGS. 9 through 11 also applies to other sections where the ASK pattern signal “ASK Pattern” becomes high.

FIG. 9 is a timing diagram illustrating embodiments of the operation of the wireless power charging system of FIG. 1. The timing diagram of FIG. 9 will hereinafter be described with reference further to the path including the differentiator 221 of FIG. 5. An example of the operation scheme of the RX device 20 for generating the second rectified gate signal QG2_{PH} is illustrated in FIG. 9 as a representative example, but the illustrated example may also apply to the operation schemes for generating the first, third, and fourth rectified gate signals QG1_{PH}, QG3_{PH}, and QG4_{PH}.

Referring to FIGS. 5, 6, 8, and 9, in a first period from t0 to t1 during the zoom-in period “Zoom-in,” the coil current sensing information V_{ISEN} sensed from the RX LC tank 28 is converted into a differentiated signal d/dt(V_{ISEN}) through the differentiator 221. The differentiated signal d/dt(V_{ISEN}) is output as a rising-edge differentiated signal RISING EDGE_DIFF and a falling-edge differentiated signal FALLING EDGE_DIFF by the zero-edge detector 231.

The timing controller 241 delays the rising-edge differentiated signal RISING EDGE_DIFF and the falling-edge differentiated signal FALLING EDGE_DIFF by preset (or alternatively, given) delay setting values SET_TRISE_MUXED and SET_TFALL_MUXED, to implement a phase difference between the differential signal (AC2_{RX}−AC1_{RX}) and the RX coil current I_{RL}, and outputs a rising-edge delay differentiated signal RISING EDGE_DIFF_DELAY and a falling-edge delay differentiated signal FALLING EDGE_DIFF_DELAY.

When the ASK phase shift control signal EN_ASK_PSHIFT based on the ASK pattern signal “ASK Pattern” is low, the RX device 20 sets the delay between the rising-edge differentiated signal RISING EDGE_DIFF and the rising-edge delay differentiated signal RISING EDGE_DIFF_DELAY (e.g., during the X0-X1 period) to T_{RISE1}, and the delay between the falling-edge differentiated signal FALLING EDGE_DIFF and the falling-edge delay differentiated signal FALLING EDGE_DIFF_DELAY (e.g., during the Y0-Y1 period) to T_{FALL1}, such that the phase difference between the differential signal (AC2_{RX}−AC1_{RX}) and the RX coil current I_{RL} becomes zero (0°). The fourth multiplexer 263 selects the gate-on signal GATE_ON3 as the rising-edge delay differentiated signal RISING EDGE_DIFF_DELAY and the gate-off signal GATE_OFF4 as the falling-edge delay differentiated signal FALLING EDGE_DIFF_DELAY.

In embodiments, the gate signal generator 264 outputs the second rectified gate signal QG2_{PH} as high when the gate-on signal GATE_ON3 is high, and outputs the second rectified gate signal QG2_{PH} as low when the gate-off signal GATE_OFF4 becomes high, thereby generating a toggling second rectified gate signal QG2_{PH}. In this manner, in the first period up to t1, the differential signal (AC2_{RX}−AC1_{RX}) and the RX coil current I_{RL} operate with a phase difference of 0°.

The other rectified gate signals, e.g., the first, third, and fourth rectified gate signals QG1_{PH}, QG3_{PH}, and QG4_{PH}, may also be generated using the same operation scheme as (or a similar operation scheme to) the second rectified gate signal QG2_{PH}. For example, the first rectified gate signal QG1_{PH} may be generated in the same phase as (or a similar phase to) the fourth rectified gate signal QG4_{PH}, and the second rectified gate signal QG2_{PH} may be generated in the same phase as (or a similar phase to) the third rectified gate signal QG3_{PH}.

In a second period from t1 to t2, where the ASK phase shift control signal EN_ASK_PSHIFT based on the ASK pattern signal “ASK Pattern” becomes high, the timing controller 241 changes the delay between the rising-edge differentiated signal RISING EDGE_DIFF and the rising-edge delay differentiated signal RISING EDGE_DIFF_DELAY (e.g., during the X2-X3 period) from T_{RISE1} to T_{RISE2}, according to the first multiplexer 121. Also, the timing controller 241 changes the delay between the falling-edge differentiated signal FALLING EDGE_DIFF and the falling-edge delay differentiated signal FALLING EDGE_DIFF_DELAY (e.g., during the Y4-Y5 period) from T_{FALL1} to T_{FALL2} according to the second multiplexer 122. In this case, the gate-on/gate-off timing of the second rectified gate signal QG2_{PH} is changed, such that the differential signal (AC2_{RX}−AC1_{RX}) lags in phase by θ° relative to the RX coil current I_{RL}, thereby enabling ASK modulation.

To disable the ASK modulation, in a third period after t2, when the ASK phase shift control signal EN_ASK_PSHIFT becomes low, the delay between the rising-edge differentiated signal RISING EDGE_DIFF and the rising-edge delay differentiated signal RISING EDGE_DIFF_DELAY (e.g., during the X4-X5 period) is restored from T_{RISE2} to T_{RISE1}. Likewise, the delay between the falling-edge differentiated signal FALLING EDGE_DIFF and the falling-edge delay differentiated signal FALLING EDGE_DIFF_DELAY (e.g., during the Y6-Y7 period) is restored from T_{FALL2} to T_{FALL1}. As a result, the phase difference between the differential signal (AC2_{RX}−AC1_{RX}) and the RX coil current I_{RL} is restored to 0°, disabling the ASK modulation.

The ASK decoder 16 of the TX device 10 generates a decoded ASK pattern signal corresponding to the ASK pattern signal “ASK Pattern” generated by the RX device 20 during the period from 0 to t3, based on a coil (L_{P}) sensing signal.

In embodiments, the delay settings T_{RISE1} and T_{RISE2}, and T_{FALL1} and T_{FALL2} may be applied identically (or similarly) to all of the first, second, third, and fourth rectified gate signals QG1_{PH}, QG2_{PH}, QG3_{PH}, and QG4_{PH}. Alternatively, in embodiments, as long as the differential signal (AC2_{RX}−AC1_{RX}) operates with a phase lag of θ° relative to the RX coil current I_{RL}, the delay settings T_{RISE1} and T_{RISE2}, and T_{FALL1} and T_{FALL2} may be applied differently to each of the first, second, third, and fourth rectified gate signals QG1_{PH}, QG2_{PH}, QG3_{PH}, and QG4_{PH}.

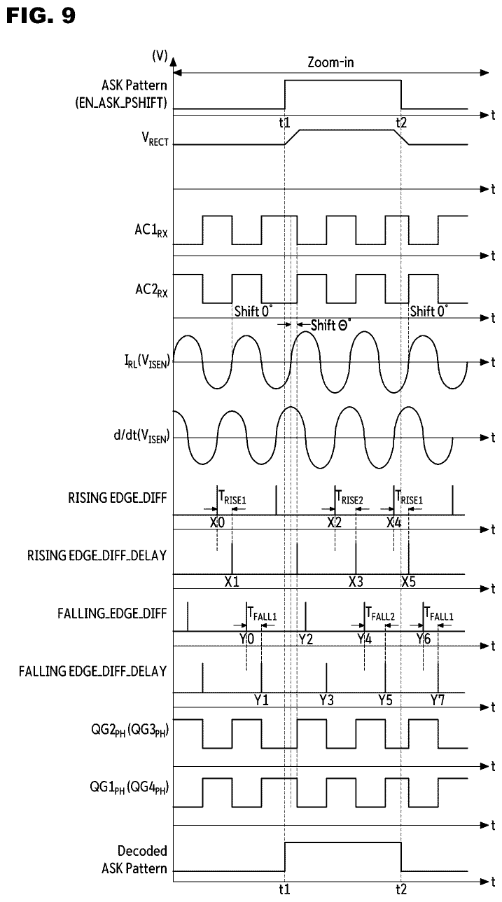

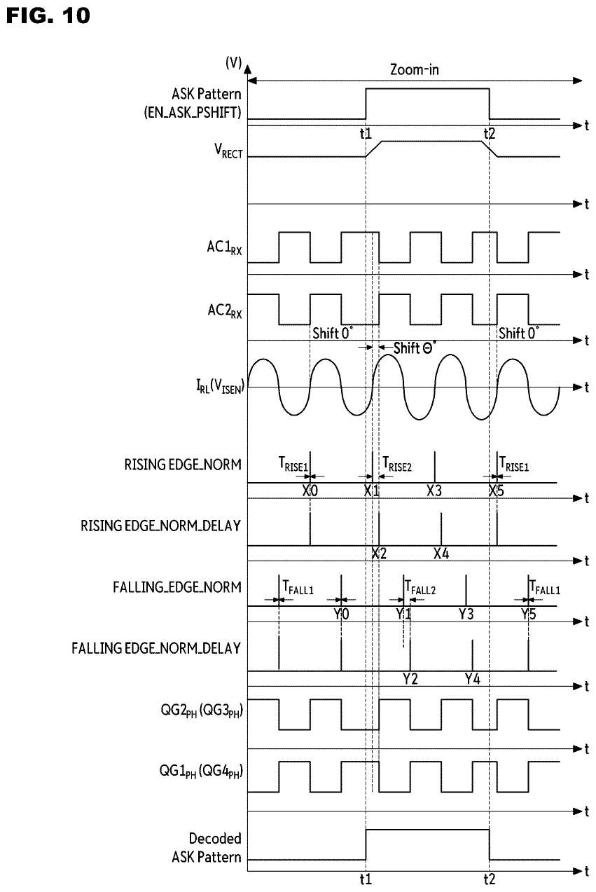

FIG. 10 is a timing diagram for explaining embodiments of the operation of the wireless power charging system of FIG. 1. The timing diagram of FIG. 10 will hereinafter be described with reference further to the path without the differentiator 221 and the integrator 222 of FIG. 5.

Referring to FIGS. 5, 6, 8, and 10, first, in a first period from t0 to t1, the zero-edge detector 232 of the RX device 20 outputs the RX coil current I_{RL} sensed from the RX LC tank 28 as a rising-edge normal signal RISING EDGE_NORM and a falling-edge normal signal FALLING EDGE_NORM.

The timing controller 242 delays the rising- and falling-edge normal signals RISING EDGE_NORM and FALLING EDGE_NORM by the preset (or alternatively, given) delay setting values SET_TRISE_MUXED and SET_TFALL_MUXED to implement a phase difference between the differential signal (AC2_{RX}−AC1_{RX}) and the RX coil current I_{RL}, and outputs a rising-edge delay normal signal RISING EDGE_NORM_DELAY and a falling-edge delay normal signal FALLING EDGE_NORM_DELAY.

When the ASK phase shift control signal EN_ASK_PSHIFT based on the ASK pattern signal “ASK Pattern” is low, the RX device 20 sets the delay between the rising-edge normal signal RISING EDGE_NORM and the rising-edge delay normal signal RISING EDGE_NORM_DELAY (e.g., at X0) to T_{RISE1}, and the delay between the falling-edge normal signal FALLING EDGE_NORM and the falling-edge delay normal signal FALLING EDGE_NORM_DELAY (e.g., at Y0) to T_{FALL1}, such that the phase difference between the differential signal (AC2_{RX}−AC1_{RX}) and the RX coil current I_{RL} becomes approximately 0°. In this case, T_{RISE1} and T_{FALL1} may be zero. The fourth multiplexer 263 selects the gate-on signal GATE_ON3 as the rising-edge delay normal signal RISING EDGE_NORM_DELAY and the gate-off signal GATE_OFF4 as the falling-edge delay normal signal FALLING EDGE_NORM_DELAY.

In embodiments, the gate signal generator 264 outputs the second rectified gate signal QG2_{PH} as high when the gate-on signal GATE_ON3 is high, and outputs the second rectified gate signal QG2_{PH} as low when the gate-off signal GATE_OFF4 becomes high, thereby generating a toggling rectified gate signal QG2_{PH}. In this manner, when the second rectified gate signal QG2_{PH} is generated, the differential signal (AC2_{RX}−AC1_{RX}) and the RX coil current I_{RL} operate with a phase difference close to 0° in the first period up to t1. At this time, when using the zero-point edges of the RX coil current I_{RL}, T_{RISE1} and T_{FALL1} become very small.

The other rectified gate signals, e.g., the first, third, and fourth rectified gate signals QG1_{PH}, QG3_{PH}, and QG4_{PH} may also be generated using the same operation scheme as (or a similar operation scheme to) the second rectified gate signal QG2_{PH}. For example, the first rectified gate signal QG1_{PH} may be generated in the same phase as (or a similar phase to) the fourth rectified gate signal QG4_{PH}, and the second rectified gate signal QG2_{PH} may be generated in the same phase as (or a similar phase to) the third rectified gate signal QG3_{PH}.

In a second period from t1 to t2, during which the ASK phase shift control signal EN_ASK_PSHIFT based on the ASK pattern signal “ASK Pattern” becomes high, the timing controller 242 changes the delay between the rising-edge normal signal RISING EDGE_NORM and the rising-edge delay normal signal RISING EDGE_NORM_DELAY (e.g., during the X1-X2 and X3-X4 periods) from T_{RISE1} to T_{RISE2} according to the first multiplexer 121. Also, the timing controller 242 changes the delay between the falling-edge normal signal FALLING EDGE_NORM and the falling-edge delay normal signal FALLING EDGE_NORM_DELAY (e.g., during the Y1-Y2 and Y3-Y4 periods) from T_{FALL1} to T_{FALL2} according to the second multiplexer 123. In this case, the gate-on/gate-off timing of the second rectified gate signal QG2_{PH} is changed, such that the differential signal (AC2_{RX}−AC1_{RX}) lags in phase by θ° relative to the RX coil current I_{RL}, thereby enabling ASK modulation.

To disable the ASK modulation, in a third period that follows t2 during the zoom-in period “Zoom-in,” when the ASK phase shift control signal EN_ASK_PSHIFT becomes low, the delay between the rising-edge normal signal RISING EDGE_NORM and the rising-edge delay normal signal RISING EDGE_NORM_DELAY (e.g., at X5) is restored from T_{RISE2} to T_{RISE1}. Likewise, the delay between the falling-edge normal signal FALLING EDGE_NORM and the falling-edge delay normal signal FALLING EDGE_NORM_DELAY (e.g., at Y5) is restored from T_{FALL2} to T_{FALL1}. As a result, the phase difference between the differential signal (AC2_{RX}−AC1_{RX}) and the RX coil current I_{RL} is restored to 0°, disabling the ASK modulation.

The ASK decoder 16 of the TX device 10 generates a decoded ASK pattern signal corresponding to the ASK pattern signal “ASK Pattern” of the RX device 20 during the period from 0 to t3, based on a TX coil (L_{P}) sensing signal.

That is, when ASK modulation is not performed (e.g., when the ASK pattern “ASK Pattern” is deactivated), the RX device 20 operates with a phase difference of 0° between the differential signal (AC2_{RX}−AC1_{RX}) and the RX coil current I_{RL}, and when ASK modulation is performed (e.g., when the ASK pattern is activated), the RX device 20 operates with a phase difference of θ° between the differential signal (AC2_{RX}−AC1_{RX}) and the RX coil current I_{RL}.

In embodiments, the delay settings T_{RISE1} and T_{RISE2}, and T_{FALL1} and T_{FALL2} may be applied identically (or similarly) to the first, second, third, and fourth rectified gate signals QG1_{PH}, QG2_{PH}, QG3_{PH}, and QG4_{PH}. Alternatively, in embodiments, as long as the differential signal (AC2_{RX}−AC1_{RX}) operates with a phase lag of θ° relative to the RX coil current I_{RL}, the delay settings T_{RISE1} and T_{RISE2}, and T_{FALL1} and T_{FALL2} may be applied differently to each of the first, second, third, and fourth rectified gate signals QG1_{PH}, QG2_{PH}, QG3_{PH}, and QG4_{PH}.

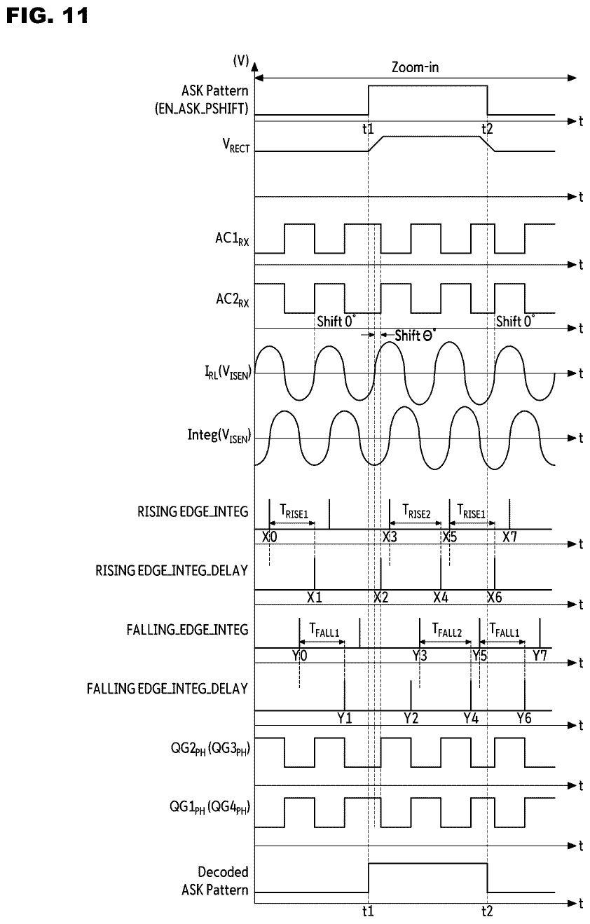

FIG. 11 is a timing diagram for explaining embodiments of the operation of the wireless power charging system of FIG. 1. The timing diagram of FIG. 11 will hereinafter be described with reference further to the path including the integrator 222 of FIG. 5.

Referring to FIGS. 5, 6, 8, and 10, first, in a first period from t0 to t1, the coil sensing information (V_{ISEN} and I_{ISEN}) is converted into an integrated signal Integ(V_{ISEN}) through the integrator 222. The integrated signal Integ(V_{ISEN}) is output from the zero-edge detector 233 as a rising-edge integrated signal RISING EDGE_INTEG and a falling-edge integrated signal FALLING EDGE_INTEG.

The timing controller 243 delays the rising- and falling-edge integrated signals RISING EDGE_INTEG and FALLING EDGE_INTEG by the preset (or alternatively, given) delay setting values SET_TRISE_MUXED and SET_TFALL_MUXED to implement a phase difference between the differential signal (AC2_{RX}−AC1_{RX}) and the RX coil current I_{RL}, and outputs a rising-edge delay integrated signal RISING EDGE_INTEG_DELAY and a falling-edge delay integrated signal FALLING EDGE_INTEG_DELAY.

When the ASK phase shift control signal EN_ASK_PSHIFT based on the ASK pattern signal “ASK Pattern” is low, the RX device 20 sets the delay between the rising-edge integrated signal RISING EDGE_INTEG and the rising-edge delay integrated signal RISING EDGE_INTEG_DELAY (e.g., during the X0-X1 period) to T_{RISE1}, and the delay between the falling-edge integrated signal FALLING EDGE_INTEG and the falling-edge delay integrated signal FALLING EDGE_INTEG_DELAY (e.g., during the Y0-Y1 period) to T_{FALL1}, such that the phase difference between the differential signal (AC2_{RX}−AC1_{RX}) and the RX coil current I_{RL} becomes 0°. The fourth multiplexer 263 selects the gate-on signal GATE_ON3 as the rising-edge delay integrated signal RISING EDGE_INTEG_DELAY and the gate-off signal GATE_OFF4 as the falling-edge delay integrated signal FALLING EDGE_INTEG_DELAY.

In embodiments, the gate signal generator 264 outputs the second rectified gate signal QG2_{PH} as high when the gate-on signal GATE_ON3 is high, and outputs the second rectified gate signal QG2_{PH} as low when the gate-off signal GATE_OFF4 becomes high, thereby generating a toggling rectified gate signal QG2_{PH}. In this manner, when the second rectified gate signal QG2_{PH} is generated, the differential signal (AC2_{RX}−AC1_{RX}) and the RX coil current I_{RL} operate with a phase difference of 0° in the first period up to t1 (“SHIFT 0°”).

The other rectified gate signals, e.g., the first, third, and fourth rectified gate signals QG1_{PH}, QG3 PH, and QG4 PH may also be generated using the same operation scheme as (or a similar operation scheme to) the second rectified gate signal QG2_{PH}. For example, the first rectified gate signal QG1_{PH} may be generated in the same phase as (or a similar phase to) the fourth rectified gate signal QG4_{PH}, and the second rectified gate signal QG2_{PH} may be generated in the same phase as (or a similar phase to) the third rectified gate signal QG3_{PH}.

In a second period from t1 to t2, during which the ASK phase shift control signal EN_ASK_PSHIFT based on the ASK pattern signal “ASK Pattern” becomes high, the timing controller 243 changes the delay between the rising-edge integrated signal RISING EDGE_INTEG and the rising-edge delay integrated signal RISING EDGE_INTEG_DELAY (e.g., during the X3-X4 and X5-X6 periods) from T_{RISE1} to T_{RISE2} according to the first multiplexer 121. Also, the timing controller 243 changes the delay between the falling-edge integrated signal FALLING EDGE_INTEG and the falling-edge delay integrated signal FALLING EDGE_INTEG_DELAY (e.g., during the Y3-Y4 and Y5-Y6 periods) from T_{FALL1} to T_{FALL2} according to the second multiplexer 122. In this case, the gate-on/gate-off timing of the second rectified gate signal QG2_{PH} is changed, such that the differential signal (AC2_{RX}−AC1_{RX}) lags in phase by θ° relative to the RX coil current I_{RL}, thereby enabling ASK modulation.

To disable the ASK modulation, in a third period after t2, when the ASK phase shift control signal EN_ASK_PSHIFT becomes low, the delay between the rising-edge integrated signal RISING EDGE_INTEG and the rising-edge delay integrated signal RISING EDGE_INTEG_DELAY (e.g., during the period after X7) is restored from T_{RISE2} to T_{RISE1}. Likewise, the delay between the falling-edge integrated signal FALLING EDGE_INTEG and the falling-edge delay integrated signal FALLING EDGE_INTEG_DELAY (e.g., during the period after Y7) is restored from T_{FALL2} to T_{FALL1}. As a result, the phase difference between the differential signal (AC2_{RX}−AC1_{RX}) and the RX coil current I_{RL} is restored to 0°, disabling the ASK modulation.

The ASK decoder 16 of the TX device 10 generates a decoded ASK pattern signal corresponding to the ASK pattern signal “ASK Pattern” generated by the RX device 20 during the period from 0 to t3, based on a coil (L_{P}) sensing signal.

In embodiments, the delay settings T_{RISE1} and T_{RISE2}, and T_{FALL1} and T_{FALL2} may be applied identically (or similarly) to the first, second, third, and fourth rectified gate signals QG1_{PH}, QG2_{PH}, QG3_{PH}, and QG4_{PH}. Alternatively, in embodiments, as long as the differential signal (AC2_{RX}−AC1_{RX}) operates with a phase lag of θ° relative to the RX coil current I_{RL}, the delay settings T_{RISE1} and T_{RISE2}, and T_{FALL1} and T_{FALL2} may be applied differently to each of the first, second, third, and fourth rectified gate signals QG1_{PH}, QG2_{PH}, QG3_{PH}, and QG4_{PH}.

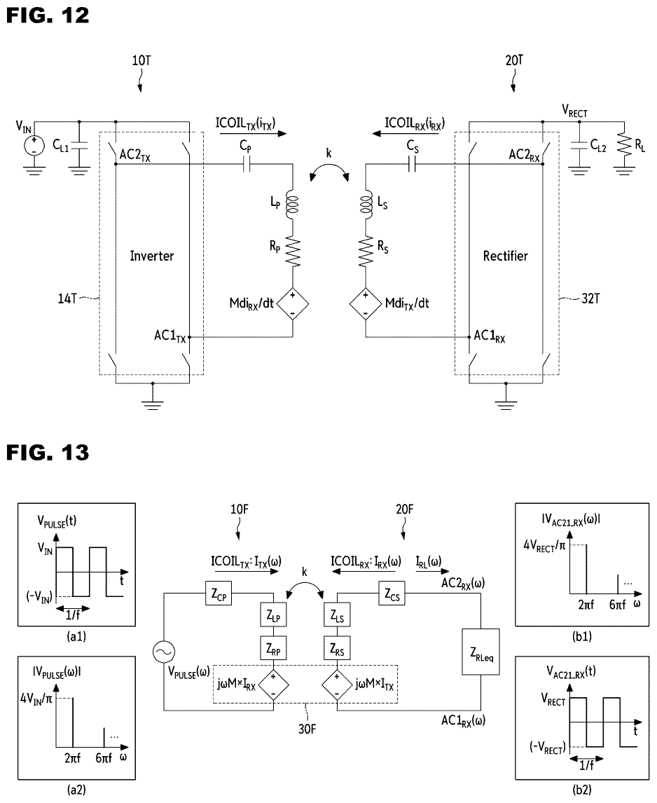

FIG. 12 illustrates the wireless power charging system of FIG. 1 as a wireless power charging transmission model in a time domain.

Referring to FIG. 12, for a theoretical explanation of an ASK communication method using active reactance control in the wireless power charging system 1, the wireless power charging system 1 will hereinafter be described as a wireless power charging transmission model in the time domain, where mutual components are expressed. A TX coil of a TX device 10T and an RX coil of the RX device 20T are coupled with a coupling factor k. The TX device 10T includes a TX bridge circuit 14T, which operates as an inverter for converting an input voltage V_{IN} into TX AC voltages AC1_{TX} and AC2_{TX}, and the RX device 20T includes a rectifier circuit 32T, which generates a rectified voltage V_{RECT} from RX AC voltages AC1_{RX} and AC2_{RX} induced in the RX coil. In the TX device 10T, there appears mutual power Mdi_{RX}/dt related to the RX coil current ICOIL_{RX}, and in the RX device 20F, there appears mutual power Mdi_{TX}/dt related to the TX coil current ICOIL_{TX}. Here, M is a mutual inductance that arises from the coupling of the inductances L_{P} and L_{S} of the TX and RX coils, and is defined as M=k\sqrt{L_{P}L_{S}}. The analysis of the wireless power charging system 1 in the time domain is complicated because it requires (or involves) higher-order differential equations using differentiation/integration of current, voltage, and power based on capacitors C, inductors L, and resistors R.

FIG. 13 is a diagram illustrating the wireless power charging transmission model of FIG. 12 in a frequency domain. The wireless power charging transmission model of FIG. 13 is obtained by transforming the wireless power charging transmission model in the time domain of FIG. 12 into the frequency domain using Fourier transform. The capacitors, inductors, and resistors in FIG. 12 may be represented as impedance components (e.g., Z_{CP}, Z_{LP}, Z_{RP}, Z_{CS}, Z_{LS}, Z_{RS}, Z_{CM}, and Z_{RLeq}) in the frequency domain. Each impedance component may be calculated by Equations 1, 2, and 3.

$${Z}_{C P} = \frac{1}{j ω {C}_{P}} , {Z}_{L P} = j ω {L}_{P} , {Z}_{R P} = {R}_{P} , {Z}_{C S} = \frac{1}{j ω {C}_{S}} \qquad [ Equation 1 ]$$

$${Z}_{L S} = j ω {L}_{S} , {Z}_{R S} = {R}_{S} , {Z}_{C M} = \frac{1}{j ω {C}_{M}} \qquad [ Equation 2 ]$$

$$M = k \sqrt{{L}_{P} {L}_{S}} \qquad [ Equation 3 ]$$

An RX-side load resistance R_{L} in FIG. 10 is transformed from the frequency domain into an equivalent rectified impedance Z_{RLeq} caused by the load resistance R_{L}, as expressed by Equation 4.

$${Z}_{R L e q} = {A}_{R L} ( \frac{8}{{π}^{2}} ) \times {R}_{L} \qquad [ Equation 4 ]$$

Here, assuming an ideal rectifier operation, A_{RL} is 1, and may vary otherwise.

In the frequency domain, the wireless power charging system 1 may be analyzed using only first-order equations while representing each impedance component and applying Ohm's law. However, since a TX device 10F and an RX device 20F are coupled, the power on each side changes according to the current on the opposite side, making it difficult to calculate an operating point. For example, the TX-side mutual power Mdi_{RX}/dt in FIG. 12 is transformed into jωM×I_{RX} in the frequency domain, and the RX-side mutual power Mdi_{TX}/dt in FIG. 12 is converted into jωM×I_{TX} in the frequency domain (collectively denoted herein as mutual power 30F). To calculate the operating point of the wireless power charging transmission model, a TX coil current I_{TX} is derived based on the RX device 20F, as indicated by Equation 5.

$${I}_{TX} = \frac{{V}_{PULSE} ( ω ) - {jwMI}_{RX}}{{Z}_{CP} + {Z}_{LP} + {Z}_{RP}} \qquad [ Equation 5 ]$$

Then, by substituting the TX coil current I_{TX} of Equation 5 into the mutual power of the RX device 20F, e.g., jωM×I_{TX}, a simplified RX-side power transmission model may be obtained as shown in Equation 6, where all the TX-side components are eliminated (or reduced), leaving only the RX-side elements.

$$j ω M \times {I}_{TX} = j ω M \times \frac{{V}_{PULSE} ( ω ) - {jwMI}_{RX}}{{Z}_{CP} + {Z}_{LP} + {Z}_{RP}} = \frac{j ω {MV}_{PULSE} ( ω )}{{Z}_{P}} - \frac{{( j ω M )}^{2} {I}_{RX}}{{Z}_{P}} \qquad [ Equation 6 ]$$

FIGS. 14A, 14B and 14C illustrate a simplified RX-side power transmission model derived from the wireless power charging transmission model of FIG. 12.

The simplified model illustrated in FIGS. 14A, 14B and 14C (may be referred to collectively herein as FIG. 14) is a circuit transformed into a unidirectional circuit (e.g., from the perspective of an RX device) from a bidirectional circuit in which the TX device 10F and the RX device 20F mutually affect each other, in order to calculate an operating point. For convenience, in this simplified RX-side power transmission model, jωM×I_{TX} in Equation 6, which represents the mutual influence of the components of the TX device 10F, is described by replacing the TX-side components with RX-side components, particularly, with reflected power V_{P_REFL} and a reflected impedance Z_{P_REFL}. In this case, the load resistance R_{L} at the rear end of the rectifier circuit 32T is expressed as a rectified impedance Z_{RLeq} between the second and first RX AC voltages AC2_{RX} and AC1_{RX}, as shown in Equation 7.

$${Z}_{RLeq} = {A}_{RL} ( \frac{8}{{π}^{2}} ) \times {R}_{L} \qquad [ Equation 7 ]$$

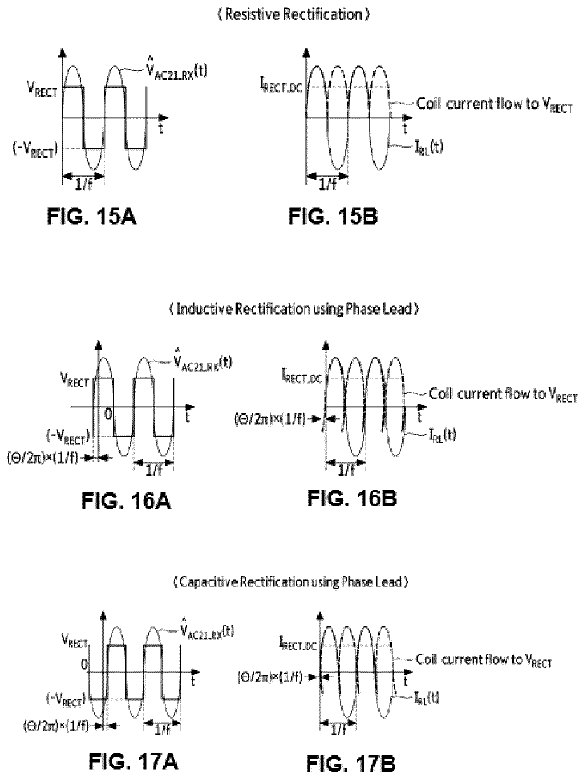

The rectified impedance Z_{RLeq} of Equation 7 will hereinafter be described in detail with reference to FIGS. 15A through 17B.

FIGS. 15A-15B present graphs for explaining resistive rectified impedance in the wireless power charging transmission models of FIGS. 12 through 14C.

Referring to FIGS. 15A and 15B (may be referred to collectively herein as FIG. 15), the rectified impedance between the second and first RX AC voltages AC2_{RX} and AC1_{RX} may be obtained by dividing a voltage V_{AC21_RX} between first and second RX AC nodes of the RX LC tank 28 by the RX coil current I_{RL}.

Referring to FIG. 15A, assuming an ideal rectifier operation, the voltage V_{AC21_RX} may be considered a square wave toggling between the rectified voltage V_{RECT} and an inverted rectified voltage −V_{RECT} at a period of 1/f. Since this toggling operation is based on the zero points of the coil sensing information (V_{ISEN} and I_{ISEN}), the phase difference between the voltage V_{AC21_RX} and the RX coil current I_{RL} converges to approximately 0°.

Therefore, under ideal conditions, the rectified impedance Z_{RLeq} may be viewed as resistive rectified impedance. Referring to FIG. 15B, the voltage V_{AC21_RX} may be approximated by extracting only the single-tone operating frequency component, as indicated by Equation 8.

$${V}_{AC 21\_ RX} ≅ {\hat{V}}_{AC 21\_ RX} = ( \frac{4}{π} ) {V}_{RECT} \times sin ( ω t ) \qquad [ Equation 8 ]$$

The RX coil current I_{RL} generally appears as a sine wave, but its amplitude is unknown. An amplitude I_{M} of the coil sensing information (V_{ISEN} and I_{ISEN}), e.g., the amplitude of the RX coil current I_{RL}, may be derived by Equation 9.

$$( \frac{1}{π} ) {\int }_{0}^{π} {I}_{RL} d ω t = ( \frac{1}{π} ) {\int }_{0}^{π} {I}_{M} sin ( ω t ) d ω t = {I}_{RECT \_ DC} \qquad [ Equation 9 ]$$

$${I}_{M} = ( \frac{π}{2} ) {I}_{RECT \_ DC}$$

The resistive rectified impedance Z_{RLeq} may be calculated from Equations 8 and 9, as indicated by Equation 10.

$${Z}_{RLeq} = \frac{{V}_{AC 21\_ RX} ( ω )}{{I}_{RL} ( ω )} ≅ \frac{( \frac{4}{π} ) {V}_{RECT}}{( \frac{π}{2} ) {I}_{RECT \_ DC}} = ( \frac{8}{{π}^{2}} ) {R}_{L} \qquad [ Equation 10 ]$$

FIGS. 16A-16B present graphs for explaining an inductive rectified impedance using phase lead, according to embodiments of the present disclosure, in the wireless power charging transmission models of FIGS. 12 through 14C.

Referring to FIGS. 16A-16B (may be referred to collectively herein as FIG. 16), the voltage V_{AC21_RX} between the first and second RX AC nodes of the RX LC tank 28 leads the phase of the coil sensing information (V_{ISEN} and I_{ISEN}), e.g., the phase of the RX coil current I_{RL}, by θ. This is achieved by shifting the phase of the rectifying synchronization operation by θ compared to the resistive impedance example (see FIGS. 8 through 10). In this case, the voltage V_{AC21_RX} is defined by Equation 11.

$${V}_{AC 21\_ RX} ≅ {\hat{V}}_{AC 21\_ RX} = ( \frac{4}{π} ) {V}_{RECT} \times sin ( ω t + θ ) \qquad [ Equation 11 ]$$

The amplitude I_{M} of the RX coil current I_{RL} changes. Since the voltage V_{AC21_RX} does not always operate in phase with the RX coil current I_{RL}, some of the current supplied as the rectified voltage V_{RECT} does not contribute to the rectifier output, but leaks. This may be reflected in the amplitude I_{M} of the coil sensing current I_{RL}, as indicated by Equation 12.

$$( \frac{1}{π} ) {\int }_{- θ}^{π - θ} {I}_{RL} d ω t = ( \frac{1}{π} ) {\int }_{- θ}^{π - θ} {I}_{M} sin ( ω t ) d ω t = {I}_{RECT \_ DC} \qquad [ Equation 12 ]$$

$${I}_{M} = ( \frac{π}{2} ) \times ( \frac{1}{cos θ} ) {I}_{{RECT}_{-} DC}$$

Now, an inductive rectified impedance Z_{RLeq} based on phase lead active reactance control is calculated by Equation 13.

$${Z}_{RLeq} = \frac{{V}_{AC {21}_{RX}} ( ω )}{{I}_{RL} ( ω )} ≅ \frac{( \frac{4}{π} ) {V}_{RECT} \times {e}^{j θ}}{( \frac{π}{2} ) ( \frac{1}{cos θ} ) {I}_{RECT \_ DC}} = ( \frac{8}{{π}^{2}} ) {R}_{L} \times cos θ ( cos θ + j sin θ ) \qquad [ Equation 13 ]$$

Referring to Equation 13, it may be seen that the inductive rectified impedance Z_{RLeq} exhibits reactive components (e.g., the complex numbers), similar to inductance.

FIGS. 17A-17B present graphs for explaining a capacitive rectified impedance using phase lag, according to embodiments of the present disclosure, in the wireless power charging transmission models of FIGS. 12 through 14C.

Specifically, FIGS. 17A-17B (may be collectively referred to herein as FIG. 17) illustrate the derivation of a capacitive rectified impedance through control of an active reactance that lags in phase. Referring to FIG. 17, when the phase of the rectified synchronization operation lags by θ compared to that of the resistive rectified impedance, the voltage V_{AC21_RX} between the first and second RX AC nodes of the RX LC tank 28 lags in phase by θ relative to the RX coil current I_{RL}. In this case, the voltage V_{AC21_RX} is expressed by Equation 14.

$${V}_{AC 21\_ RX} ≅ {\hat{V}}_{AC {21}_{RX}} = ( \frac{4}{π} ) {V}_{RECT} \times sin ( ω t - θ ) \qquad [ Equation 14 ]$$

The I_{M} of the RX coil current I_{RL} changes. Since the voltage V_{AC21_RX} does not always operate in phase with the RX coil current I_{RL}, some of the current supplied as the rectified voltage V_{RECT} is not provided as rectifier output, but instead leaks. This may be reflected in the amplitude I_{M} of the RX coil current I_{RL}, as indicated by Equation 15.

$$( \frac{1}{π} ) {\int }_{+ θ}^{π + θ} {I}_{RL} d ω t = ( \frac{1}{π} ) {\int }_{+ θ}^{π + θ} {I}_{M} sin ( ω t ) d ω t = {I}_{RECT \_ DC} \qquad [ Equation 15 ]$$

$${I}_{M} = ( \frac{π}{2} ) \times ( \frac{1}{cos θ} ) {I}_{RECT \_ DC}$$

Now, a capacitive rectified impedance Z_{RLeq} based on phase lag reactance control is calculated by Equation 16.

$${Z}_{RLeq} = \frac{{V}_{AC {21}_{RX}} ( ω )}{{I}_{RL} ( ω )} ≅ \frac{( \frac{4}{π} ) {V}_{RECT} \times {e}^{j ( - θ )}}{( \frac{π}{2} ) ( \frac{1}{cos θ} ) {I}_{RECT \_ DC}} = ( \frac{8}{{π}^{2}} ) {R}_{L} \times cos θ ( cos θ - j sin θ ) \qquad [ Equation 16 ]$$

Referring to Equation 16, it may be seen that the capacitive rectified impedance Z_{RLeq} exhibits a reactive component (e.g., the complex number), similar to capacitance.

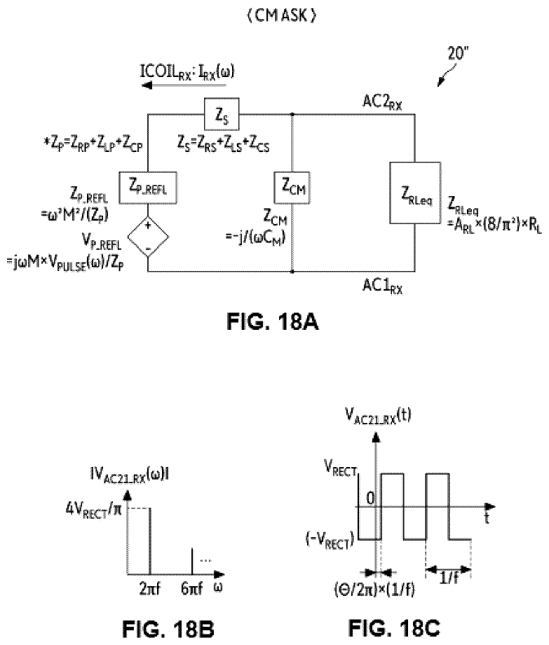

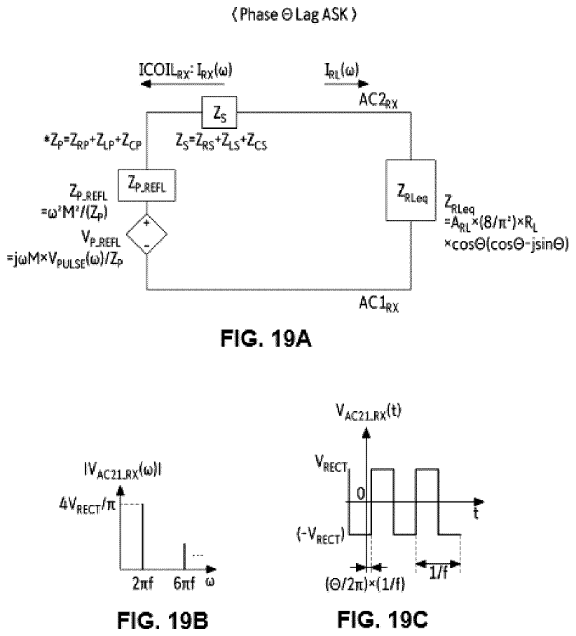

FIGS. 18A-18C illustrate an RX-side power transmission model in a wireless power charging transmission model using external capacitors according to a comparative example, and FIGS. 19A-19C illustrate an RX-side power transmission model in a wireless power charging transmission model using phase shift according to embodiments of the present disclosure.

Referring to the wireless power charging system of FIGS. 18A-18C (may be collectively referred to herein as FIG. 18), in an RX device 20″, first and second external capacitors C_{CM1} and C_{CM2} are respectively connected between an AC1_{RX} node and a ground node, and between an AC2_{RX} node and the ground node. An impedance Z_{CM} due to the first and second external capacitors C_{CM1} and C_{CM2} is used for ASK communication. This type of ASK modulation will hereinafter be referred to as common mode (CM) ASK modulation using external capacitors.

The impedance Z_{CM} in FIG. 18 is calculated by Equation 17.

$${Z}_{CM} = \frac{1}{j ω {C}_{M}} = \frac{1}{j ω ( {C}_{CM 1} // {C}_{CM 2} )} \qquad [ Equation 17 ]$$

When the first external capacitor CM1 is present between the AC1_{RX} node and the ground node, and the second external capacitor CM2 is present between the AC2_{RX} node and the ground node, due to CM ASK modulation, or equivalently, when the first and second external capacitors C_{CM1} and C_{CM2} are present between the AC1_{RX} and AC2_{RX} nodes, a total load impedance Z_{RLCM} is expressed as a parallel impedance of an equivalent rectified impedance Z_{RLeq} due to the load resistance R_{L} and the impedance Z_{CM} due to the first and second external capacitors, as indicated by Equation 18.

$${Z}_{RLCM} = {Z}_{RLeq} // {Z}_{CM} = \frac{\vert {Z}_{RLeq} \vert \vert {Z}_{CM} \vert {e}^{j ( - \frac{π}{2} )}}{( \sqrt{{( {Z}_{RLeq} )}^{2} + {( {Z}_{CM} )}^{2}} ) \times {e}^{j {θ}_{RL \_ plus \_ CM}}} \qquad [ Equation 18 ]$$

Here, θ_{RL_plus_CM}=Phase(Z_{RLeq}+Z_{CM}). By applying the definition of θ_{RL_plus_CM} to Equation 1), Equation 19 is derived as follows.

$${Z}_{RLCM} = \vert {Z}_{RLeq} \vert \times ( - 1 ) \times sin ( {θ}_{RL \_ plus \_ CM} ) {e}^{j ( ( - \frac{π}{2} ) - {θ}_{RL \_ plus \_ CM} )} = \vert {Z}_{RLeq} \vert \times ( - 1 ) \times sin ( ( - \frac{π}{2} ) - {θ}_{RL \_ plus \_ CM} ) {e}^{j {θ}_{RLCM}} \qquad [ Equation 19 ]$$

Here, θ_{RLCM}=Phase(Z_{RLCM}). Continuing with the derivation of Equation 19, the total load impedance Z_{RLCM} is defined by Equation 20.

$${Z}_{RLCM} = {A}_{RL} ( \frac{8}{{π}^{2}} ) {R}_{L} cos ( {θ}_{RLCM} ) ( cos ( {θ}_{RLCM} ) + j sin ( {θ}_{RLCM} ) ) \qquad [ Equation 20 ]$$

Comparing the total load impedance Z_{RLCM} during CM ASK modulation with the load impedance Z_{RLeq} obtained through active reactance control using a phase lag of θ, as shown in the wireless power transmission model of FIGS. 19A-19C and Equation 16, results in Equation 21.

If θ=(−1)×θ_{RLCM}, then Z_{RLCM}=Z_{RLeq} [Equation 21]

### In Phase Lag Active Reactance Control

Referring to Equation 21, it can be seen that by applying a phase lag of θ (=(−1)×θ_{RLCM}), the same modulation effect as (or a similar modulation effect to) CM ASK may be obtained. Therefore, according to the present disclosure, the same modulation effect as (or a similar modulation effect to) CM ASK may be obtained without using external capacitors, only through active reactance control based on phase lag by the rectifying synchronization phase-shift controller 100.

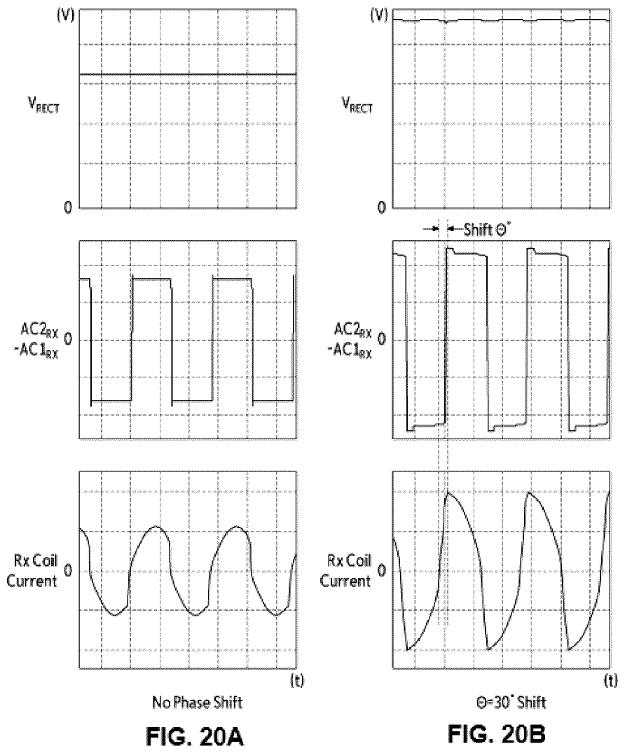

FIGS. 20A-20B presents graphs respectively showing the magnitudes of the rectified voltage, RX AC voltages, and RX coil current in the RX device 20 when no phase shift is applied and when a phase lag of 30° is applied according to embodiments of the present disclosure.

Referring to FIGS. 20A and 20B (may be collectively referred to herein as FIG. 20), the amplitude of the RX coil current I_{RL} (“Rx Coil Current”), the differential signal (AC2_{RX}−AC1_{RX}), generated based on the sensing result of the RX coil current I_{RL}, and the rectified voltage V_{RECT}, generated based on the differential signal (AC2_{RX}−AC1_{RX}), are greater when a phase lag of 300 is applied than when no phase shift is applied. It can be inferred that ASK modulation is achieved such that as the RX coil current I_{RL} increases and the TX coil current I_{TX} also increases accordingly.

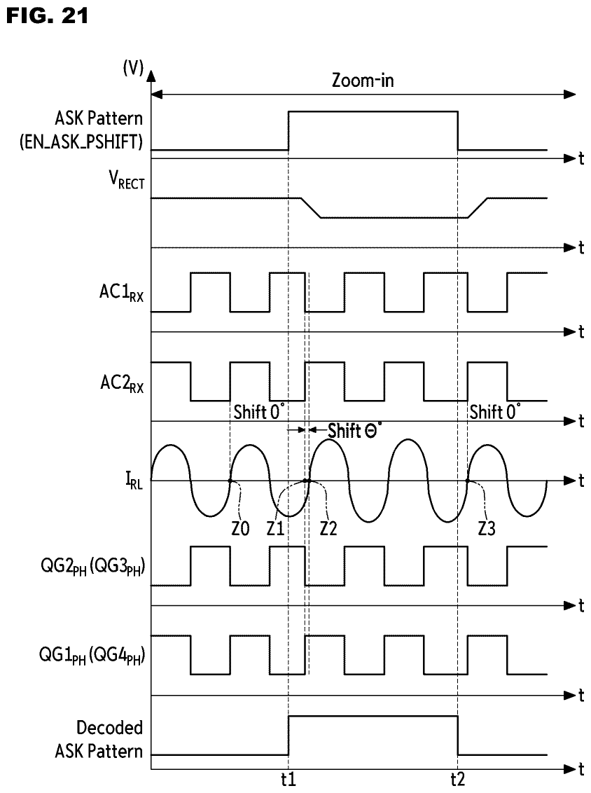

FIG. 21 is a timing diagram illustrating embodiments of the operation of the wireless power charging system of FIG. 1. The example of FIG. 21 implements phase shift in the opposite direction to that in the examples of FIGS. 9 through 11. In this specification, a phase lead refers to a phase shift in the direction opposite to a phase lag. For example, a phase lead refers to leading the differential signal (AC2_{RX}−AC1_{RX}) by θ relative to the RX coil current I_{RL}. FIGS. 9 through 11 present timing diagrams of examples of a phase lag, while FIG. 21 presents a timing diagram of an example of phase lead.

Referring to FIG. 21, when the ASK pattern signal “ASK Pattern” is deactivated (or low), the RX device 20 sets the phase difference between the differential signal (AC2_{RX}−AC1_{RX}) and the RX coil current I_{RL} to 0° (e.g., at Z0), and generates the rectified gate signals QG1_{PH}, QG2_{PH}, QG3_{PH}, and QG4_{PH} accordingly.

During the period from t1 to t2, if the ASK pattern signal “ASK Pattern” is activated (or high) but the rectified voltage V_{RECT} drops below a preset (or alternatively, given) level, the rectifying synchronization phase-shift controller 100 performs active reactance control to generate the rectified gate signals QG1_{PH}, QG2_{PH}, QG3_{PH}, and QG4_{PH} such that the differential signal (AC2_{RX}−AC1_{RX}) leads the RX coil current I_{RL} by θ (e.g., during the Z1-Z2 period). As a result, the load impedance of the RX device 20 is converted into an inductive rectified impedance.

In embodiments, the active reactance control of the rectifying synchronization phase-shift controller 100 may be either control according to a preset (or alternatively, given) θ value to induce a resonance characteristic change, or gradual control toward a preset (or alternatively, given) target rectified voltage V_{RECT_TARGET}.

Then, when the ASK pattern signal “ASK Pattern” is deactivated (or becomes logic low) again, the rectifying synchronization phase-shift controller 100 generates the rectified gate signals QG1_{PH}, QG2_{PH}, QG3 PH, and QG4 PH to restore the phase difference between the differential signal (AC2_{RX}−AC1_{RX}) and the RX coil current I_{RL} to 0° (e.g., after Z3). Once the phase previously lead by θ° is restored back to 0°, the level of the rectified voltage V_{RECT} may increase.

Being coupled with the RX device 20 in which ASK modulation by a phase lead occurs, the TX device 10 may perform decoding such that a decoded ASK pattern signal “Decoded ASK Pattern” from the TX coil current I_{TX} matches the ASK pattern signal “ASK Pattern” from the RX device 20 (e.g., ASK Pattern=Decoded ASK Pattern)

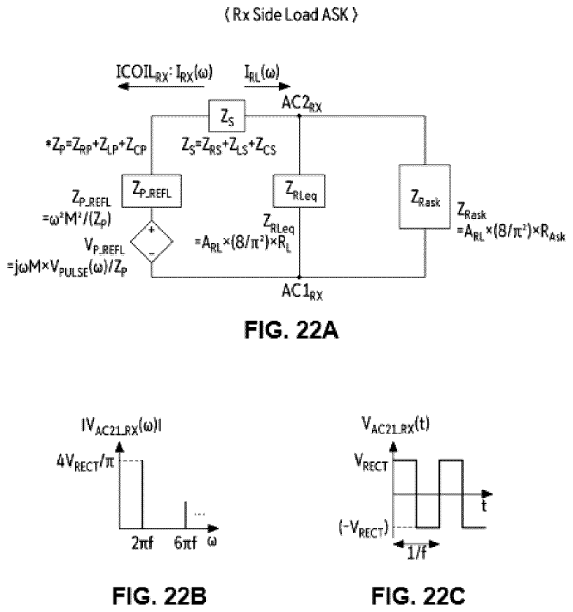

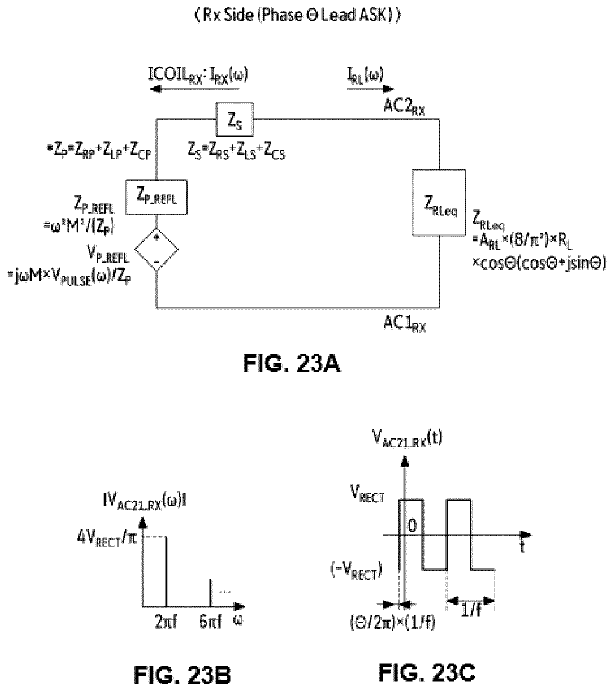

FIGS. 22A-22C explains a circuit diagram illustrating a simplified model of an RX-side power system according to a load ASK communication scheme of a comparative example, and FIGS. 23A-23C include a circuit diagram illustrating a simplified model of an RX-side power system according to the example of FIG. 21.

Referring to FIGS. 22A-22C (may be collectively referred to as FIG. 22), when only load ASK modulation is used, a total load impedance Z_{RLRASK} in the frequency domain may be expressed by Equation 22.

$${Z}_{RLRASK} = {Z}_{RLeq} // {Z}_{Rask} = {A}_{RL} ( \frac{8}{{π}^{2}} ) ( {R}_{L} // {R}_{ASK} ) \qquad [ Equation 22 ]$$

Compared to the equivalent load impedance Z_{RLeq} when only the load resistance R_{L} is present, the total load impedance Z_{RLASK} becomes smaller in magnitude, and accordingly, the voltage V_{AC21_RX} across a load impedance Zs may also decrease in magnitude.

In phase-lead ASK modulation as in FIGS. 23A-23C, the equivalent load impedance Z_{RLeq} of the RX device 20 in the frequency domain may be calculated by Equation 23.

$${Z}_{RLeq} = {A}_{R L} ( \frac{8}{{π}^{2}} ) {R}_{L} cos θ ( cos θ + j sin θ ) \qquad [ Equation 23 ]$$

Here, A_{RL}, which is a constant for reflecting an actual rectification state, may be 1 in an ideal rectification state, or may be slightly less than 1 in a non-ideal rectification state.

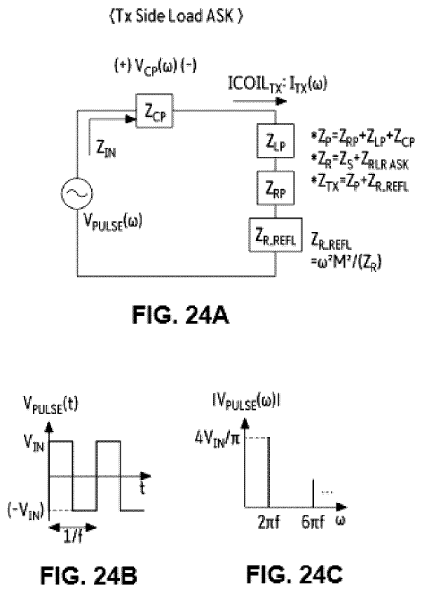

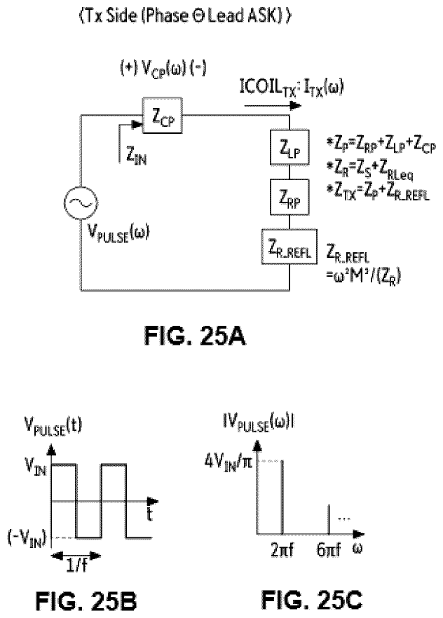

FIGS. 24A-24C explains a circuit diagram illustrating a simplified model of a TX-side power system according to the load ASK communication scheme of the comparative example, and FIGS. 25A-25C explains a circuit diagram illustrating a simplified model of a TX-side power system according to the example of FIG. 21.

Referring to FIGS. 24A-24C (may also be referred to collectively herein as FIG. 24) and 25A-25C (may also be referred to collectively herein as FIG. 25) together with FIG. 11, a simplified TX-side power system model with coupling-related cyclic dependencies resolved may be derived by substituting

$${I}_{RX} = \frac{{j ω MI}_{TX}}{{Z}_{CS} + {Z}_{LS} + {Z}_{RS} + {Z}_{RLeq}} = \frac{{j ω MI}_{TX}}{{Z}_{S} + {Z}_{RLeq}}$$

into TX power jωM×I_{RX} of the TX device 10F. In the TX device 10F, a TX coil current I_{TX}(ω) and a voltage V_{CP}(ω) across the impedance Z_{CP} due to a compensation capacitor C_{P} may be derived in the frequency domain, as indicated by Equations 24 and 25.

$${I}_{TX} ( ω ) = \frac{{V}_{PULSE}}{{Z}_{TX}} = \frac{{V}_{PULSE}}{{Z}_{P} + ( \frac{{ω}^{2} {M}^{2}}{\vert {Z}_{R} \vert} ) {e}^{j ( - {θ}_{ZR} )}} = \frac{{V}_{PULSE} ( ω )}{( {R}_{P} + ( \frac{{ω}^{2} {M}^{2}}{\vert {Z}_{R} \vert} ) ( \frac{{R}_{R}}{\vert {Z}_{R} \vert} ) + j ( {X}_{P} - ( \frac{{ω}^{2} {M}^{2}}{\vert {Z}_{R} \vert} ) ( \frac{{X}_{R}}{\vert {Z}_{R} \vert} ) )} \qquad [ Equation 24 ]$$

V_{CP}(ω)=I_{TX}(ω)×Z_{CP} [Equation 25]

Here, a phase θ_{ZR} due to the resistance in the TX LC tank 18 is defined as θ_{ZR}=Phase(Z_{R}).

According to Equations 24 and 25, during ASK modulation, the magnitude or phase of the TX coil current I_{TX}(ω) and the voltage V_{CP} across the TX compensation capacitor C_{P} may vary.

Referring to FIGS. 24 and 25, when the RX-side load impedance changes, a reflected impedance Z_{R_REFL} on the TX device 10F changes due to coupling. The TX coil current I_{TX}(ω) varies according to the reflected impedance Z_{R_REFL}. The variation of the TX coil current I_{TX}(ω) during load ASK modulation due to a load resistance R_{L} may be expressed by Equation 26.

$${I}_{TX} ( ω ) = \frac{{V}_{PULSE} ( ω )}{\begin{matrix}( {R}_{P} + ( \frac{{ω}^{2} {M}^{2}}{\vert {Z}_{R} \vert} ) ( \frac{{R}_{S} + {A}_{RL} ( \frac{8}{{π}^{2}} ) ( {R}_{L} // {R}_{ASK} )}{\vert {Z}_{R} \vert} ) ) + \\ j ( {X}_{P} - ( \frac{{ω}^{2} {M}^{2}}{\vert {Z}_{R} \vert} ) ( \frac{{X}_{S}}{\vert {Z}_{R} \vert} ) )\end{matrix}} \qquad [ Equation 26 ]$$

The variation of the TX coil current I_{TX}(ω) during phase-lead ASK modulation may be expressed by Equation 27.

$${I}_{TX} ( ω ) = \frac{{V}_{PULSE} ( ω )}{\begin{matrix}( {R}_{P} + ( \frac{{ω}^{2} {M}^{2}}{\vert {Z}_{R} \vert} ) ( \frac{{R}_{S} + {A}_{RL} ( \frac{8}{{π}^{2}} ) {{R}_{L} ( cosθ )}^{2}}{\vert {Z}_{R} \vert} ) ) + \\ j ( {X}_{P} - ( \frac{{ω}^{2} {M}^{2}}{\vert {Z}_{R} \vert} ) ( \frac{{R}_{S} + {A}_{RL} ( \frac{8}{{π}^{2}} ) {{R}_{L} ( cosθ )}^{2}}{\vert {Z}_{R} \vert} ) )\end{matrix}} \qquad [ Equation 27 ]$$

Additionally, based on Equation 22, a magnitude |I_{RX}(ω)| of an RX coil current I_{RX}(ω) during load ASK modulation due to the load resistance may be expressed as shown in Equation 28.

$$\vert {I}_{RX} ( ω ) \vert = \vert \frac{{V}_{P \_ REFL} ( ω )}{{Z}_{P \_ REFL} + {Z}_{S} + {A}_{RL} ( \frac{8}{{π}^{2}} ) ( {R}_{L} // {R}_{ASK} )} \vert \qquad [ Equation 28 ]$$

Also, based on Equation 23, the RX coil current magnitude |I_{RX}(ω)| during phase-lead ASK modulation may be expressed by Equation 29.

$$\vert {I}_{RX} ( ω ) \vert = \vert \frac{{V}_{P \_ REFL} ( ω )}{{Z}_{P \_ REFL} + {Z}_{S} + {A}_{RL} ( \frac{8}{{π}^{2}} ) {R}_{L} cosθ ( cosθ + j sinθ )} \vert \qquad [ Equation 29 ]$$

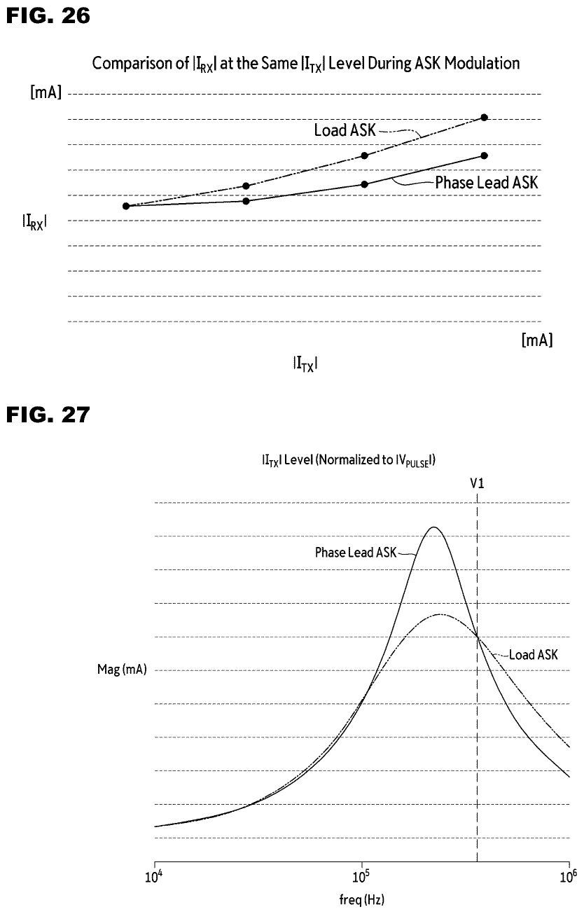

FIG. 26 is a voltage-current graph for comparing and explaining the operations of the wireless power charging transmission system according to the load ASK communication scheme of the comparative example and the wireless power charging transmission system of FIG. 21, and FIG. 27 is a frequency-coil current graph for comparing and explaining the operations of the wireless power charging transmission system according to the load ASK communication scheme of the comparative example and the wireless power charging transmission system of FIG. 21.

Referring to FIG. 26, based on Equations 26 and 28 for load ASK modulation and Equations 27 and 29 for phase-lead ASK modulation, these two ASK modulation schemes may be analyzed in terms of the correlation between a magnitude |I_{TX}| of the TX coil current I_{TX} and a magnitude |I_{RX}| of the RX coil current I_{RX}. Analyzing the RX coil current magnitude |I_{RX}| in the two ASK modulation schemes after matching the TX coil current magnitude |I_{TX}|(i.e., the depth of the ASK pattern) similarly between the two ASK modulation schemes shows that that the RX coil current I_{RX} tends to be lower in phase-lead ASK modulation than in load ASK modulation.

An analysis of the RX coil current magnitude |I_{RX}| in the two ASK modulation schemes at the same ASK pattern depth (or similar ASK pattern depths) shows that, at a given power transmission frequency V1 of FIG. 26, the RX coil current I_{RX} is lower in phase-lead ASK modulation than in load ASK modulation. This means that, based on the same ASK pattern depth (or similar ASK pattern depths), power consumption or heat generation due to the RX coil current I_{RX} during phase-lead ASK is more advantageous than that during load ASK modulation.

As shown in FIG. 27, at the same power transmission frequency V1 (or similar power transmission frequencies) and for the same TX coil current magnitude |I_{TX}|(or similar TX coil current magnitudes) (e.g., the same ASK depth or similar ASK depths), the quality factor of the TX coil current I_{TX} is higher in phase-lead ASK modulation than in load ASK modulation. Here, the quality factor, which is an index representing the attenuation performance in frequency bands other than the resonance frequency, is calculated as (resonant frequency/bandwidth, e.g., as a ratio of resonant frequency to bandwidth).

The imaginary part of the TX coil current I_{TX} in phase-lead ASK modulation, e.g.,

$$( {X}_{P} - ( \frac{{ω}^{2} {M}^{2}}{\vert {Z}_{R} \vert} ) ( \frac{{X}_{S} + {A}_{RL} ( \frac{8}{{π}^{2}} ) {R}_{L} cosθsinθ}{\vert {Z}_{R} \vert} ) )$$

in Equation 27, increases more with a frequency ω due to the additional imaginary term,

$$\frac{{A}_{RL} {R}_{L} cosθsinθ}{\vert {Z}_{R} \vert} ,$$

compared to its counterpart in load ASK modulation, e.g.,

$$( {X}_{P} - ( \frac{{ω}^{2} {M}^{2}}{\vert {Z}_{R} \vert} ) ( \frac{{X}_{S}}{\vert {Z}_{R} \vert} ) )$$

in Equation 26. That is, a phase shift of θ° has a greater impact as the frequency ω increases. Therefore, in phase-lead ASK modulation, the resonance point shifts to a lower frequency compared to load ASK modulation, and the TX coil current I_{TX} increases, resulting in a higher peak on the left side of the graph of FIG. 27 with respect to V1.

Since the quality factor of the TX coil current I_{TX} in phase-lead ASK modulation is higher than that in load ASK modulation, phase-lead ASK becomes more robust to external distortion in high-frequency bands outside the power transmission frequency. Therefore, at the same ASK depth (or similar ASK depths), phase-lead ASK is advantageous over load ASK in terms of reduced power loss due to a lower RX coil current |I_{RX}|, and also has better robustness to external noise due to a higher quality factor.

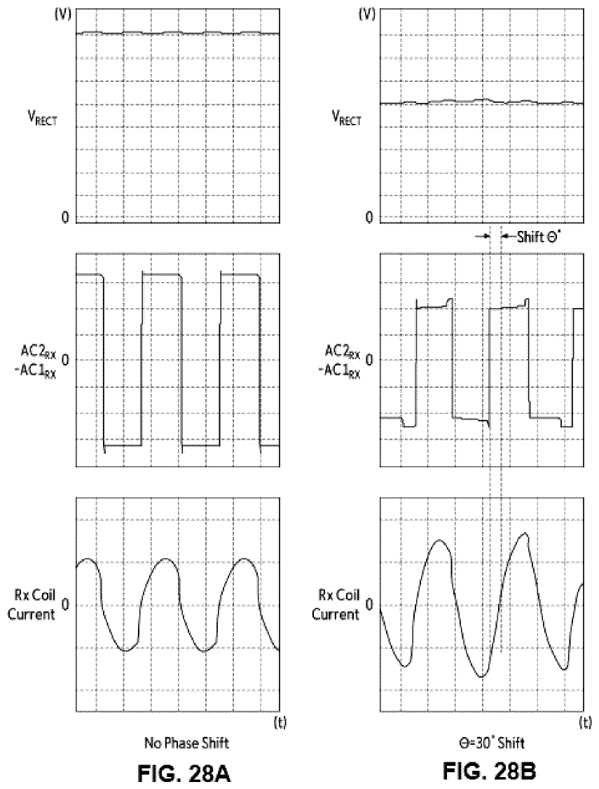

FIGS. 28A-28B present graphs respectively showing the magnitudes of the rectified voltage, RX AC voltages, and RX coil current in the RX device 20 when no phase shift is applied and when a phase lead of 30° is applied according to embodiments of the present disclosure.

Referring to FIGS. 28A and 28B (may be collectively referred to herein as FIG. 28), the differential signal (AC2_{RX}−AC1_{RX}), generated based on the RX coil current I_{RL}, and the rectified voltage V_{RECT}, generated based on the differential signal (AC2_{RX}−AC1_{RX}), are smaller when a phase lead of 30° is applied than when no phase shift is applied. On the other hand, the amplitude of the RX coil current I_{RL} (“Rx Coil Current”) is greater when a phase lead of 30° is applied than when no phase shift is applied. From this, it can be inferred that ASK modulation is achieved such that, as the RX coil current I_{RL} increases, the TX coil current I_{TX} also increases accordingly.

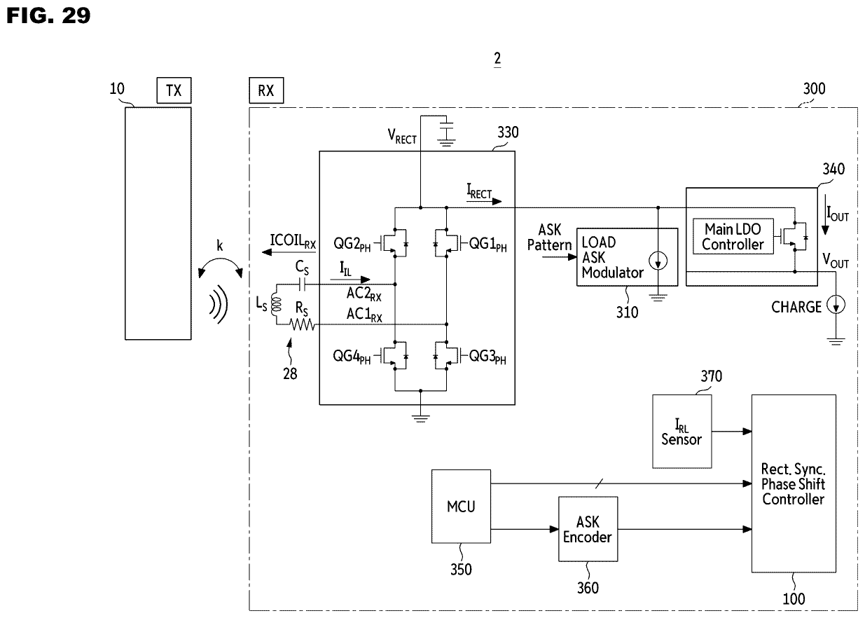

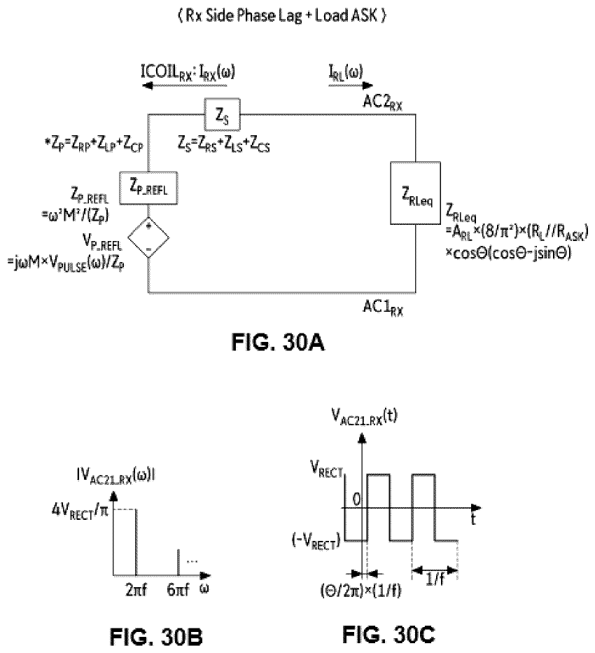

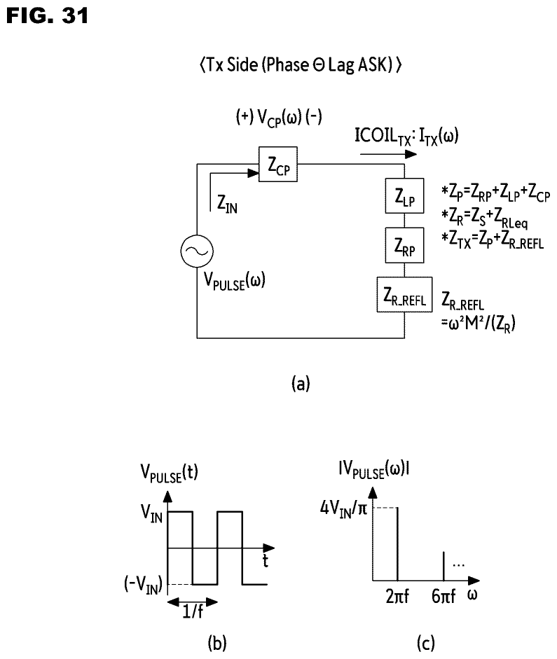

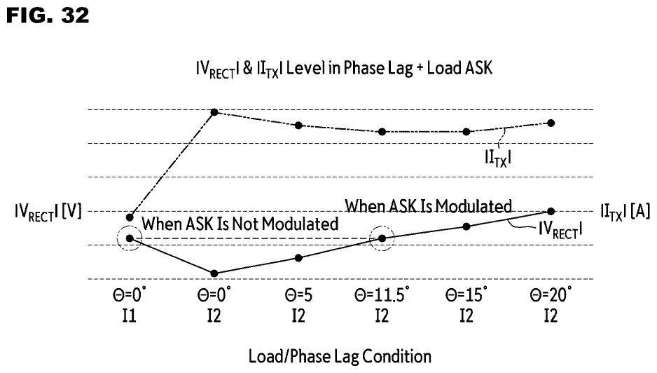

FIG. 29 is a circuit diagram of a wireless power charging system 2 according to embodiments of the present disclosure. FIGS. 30A-30C illustrate an RX-side power transmission model in the frequency domain of an RX device 300 in FIG. 29, and FIGS. 31A-31B illustrate a TX-side power transmission model in the frequency domain of the TX device 10 in FIG. 29. FIG. 32 is a graph showing a magnitude |V_{RECT}| of a rectified voltage V_{RECT} and a magnitude |I_{TX}| of a TX coil current I_{TX} in the wireless power charging system 2 for a phase lag of θ°.

Referring to FIG. 29, the wireless power charging system 2 includes the TX device 10 and the RX device 300 that may use both phase-lag ASK modulation and load ASK modulation. For example, the RX device 300 may include a load ASK modulator 310, an RX LC tank 28, a rectifier circuit 330, a main LDO circuit 340, an RX MCU 350, an ASK encoder 360, a coil current sensor 370, a rectifying synchronization phase-shift controller 100, and/or a battery CHARGE. The RX LC tank 28, rectifier circuit 330, main LDO circuit 340, RX MCU 350, ASK encoder 360, coil current sensor 370, rectifying synchronization phase-shift controller 100, and/or battery CHARGE correspond to their respective counterparts in FIG. 1, and thus, detailed descriptions thereof will be omitted.

The load ASK modulator 310 varies a load current I_{R} to change the resonance characteristics of the wireless power charging system 2. For example, in response to an ASK pattern signal “ASK Pattern” received from the ASK encoder 360, the load ASK modulator 310 may connect/disconnect a preset (or alternatively, given) load current I_{R} to change a rectified voltage V_{RECT} (or a rectified current I_{RECT}) supplied to the main LDO circuit 340.

When only load ASK modulation is performed without phase-lag ASK modulation, the RX-side power transmission model is expressed as illustrated in FIGS. 22A-22B, and the rectified voltage magnitude |V_{RECT}| is calculated by Equation 30.

$$\vert {V}_{RECT} \vert ≅ \frac{π}{4} {V}_{P \_ REFL} ( \frac{{A}_{RL} ( \frac{8}{{π}^{2}} ) ( {R}_{L} // {R}_{ASK} )}{\sqrt{{( {R}_{RX} + {A}_{RL} ( \frac{8}{{π}^{2}} ) ( {R}_{L} // {R}_{ASK} ) )}^{2} + {( {X}_{RX} )}^{2}}} ) \qquad [ Equation 30 ]$$

When only load ASK modulation is performed, since a modulation resistance R_{ASK} is connected in parallel to a load resistance R_{L}, the rectified voltage magnitude |V_{RECT}| becomes smaller than in the presence of the load resistance R_{L} only.

Referring to FIGS. 30A-30C, in an RX device 300 where phase-lag ASK modulation and load ASK modulation are both performed, the rectified voltage magnitude |V_{RECT}| may be expressed by Equation 31.

$$\vert {V}_{RECT} \vert ≅ \frac{π}{4} {V}_{P \_ REFL} ( \frac{{A}_{RL} ( \frac{8}{{π}^{2}} ) ( {R}_{L} // {R}_{ASK} )}{\sqrt{\begin{matrix}{( {R}_{RX} + {A}_{RL} ( \frac{8}{{π}^{2}} ) ( {R}_{L} // {R}_{ASK} ) ( cosθ ) )}^{2} + \\ {( {X}_{RX} - {A}_{RL} ( \frac{8}{{π}^{2}} ) ( {R}_{L} // {R}_{ASK} ) cosθsinθ )}^{2}\end{matrix}}} ) \qquad [ Equation 31 ]$$

When phase-lag ASK modulation and load ASK modulation are both performed, the effect of a decrease in the rectified voltage V_{RECT} due to the modulation resistance R_{ASK} and the effect of an increase in the rectified voltage V_{RECT} due to a reduction in the imaginary component in Equation 31 both exist. Thus, the rectified voltage magnitude |V_{RECT}| may remain relatively stable even during ASK modulation.

Referring to FIGS. 31A-31C, when phase-lag ASK modulation and load ASK modulation are both performed, the TX coil current I_{TX} may undergo substantial modulation. The TX coil current I_{TX} when only load ASK modulation is performed and the TX coil current I_{TX} when phase-lag ASK modulation and load ASK modulation are both performed are expressed by Equations 32 and 33, respectively.

$${I}_{TX} ( ω ) = \frac{{V}_{PULSE} ( ω )}{\begin{matrix}( {R}_{P} + ( \frac{{ω}^{2} {M}^{2}}{\vert {Z}_{R} \vert} ) ( \frac{{R}_{S} + {A}_{RL} ( \frac{8}{{π}^{2}} ) ( {R}_{L} // {R}_{ASK} )}{\vert {Z}_{R} \vert} ) ) + \\ j ( {X}_{P} - ( \frac{{ω}^{2} {M}^{2}}{\vert {Z}_{R} \vert} ) ( \frac{{X}_{S}}{\vert {Z}_{R} \vert} ) )\end{matrix}} \qquad [ Equation 32 ]$$

$${I}_{TX} ( ω ) = \frac{{V}_{PULSE} ( ω )}{\begin{matrix}( \begin{matrix}{R}_{P} + ( \frac{{ω}^{2} {M}^{2}}{\vert {Z}_{R} \vert} ) \\ ( \frac{{R}_{S} + {A}_{RL} ( \frac{8}{{π}^{2}} ) ( {R}_{L} // {R}_{ASK} ) {( cosθ )}^{2}}{\vert {Z}_{R} \vert} )\end{matrix} ) + \\ j ( \begin{matrix}{X}_{P} - ( \frac{{ω}^{2} {M}^{2}}{\vert {Z}_{R} \vert} ) \\ ( \frac{{X}_{S} + {A}_{RL} ( \frac{8}{{π}^{2}} ) ( {R}_{L} // {R}_{ASK} ) cosθsinθ}{\vert {Z}_{R} \vert} )\end{matrix} )\end{matrix}} \qquad [ Equation 33 ]$$

In load ASK modulation, the load ASK modulator changes the power consumption in the RX device 20 by varying the modulation resistance R_{ASK}, thereby affecting the TX-side current. Specifically, the modulation resistance R_{ASK} affects the TX coil current I_{TX} through the denominator of Equation 32.

When phase-lag ASK modulation and load ASK modulation are both performed, the variation in the TX coil current I_{TX} due to a change in the load resistance R_{L} may be reduced by the cosine and sine functions of θ in the denominator of Equation 33.

Referring to FIG. 32, when ASK modulation is not performed, the rectified voltage magnitude |V_{RECT}| and the rectified current magnitude |I_{RECT}| change more drastically at a current I1 than at a current I2 in the absence of a phase shift (θ=0°). However, when phase-shift ASK modulation is performed at the same current I2 (θ=5°, 11.5°, 15°, 20°), such changes in the rectified voltage magnitude |V_{RECT}| and the rectified current magnitude |I_{RECT}| are smaller and tend to remain stable compared to when ASK modulation is not performed.

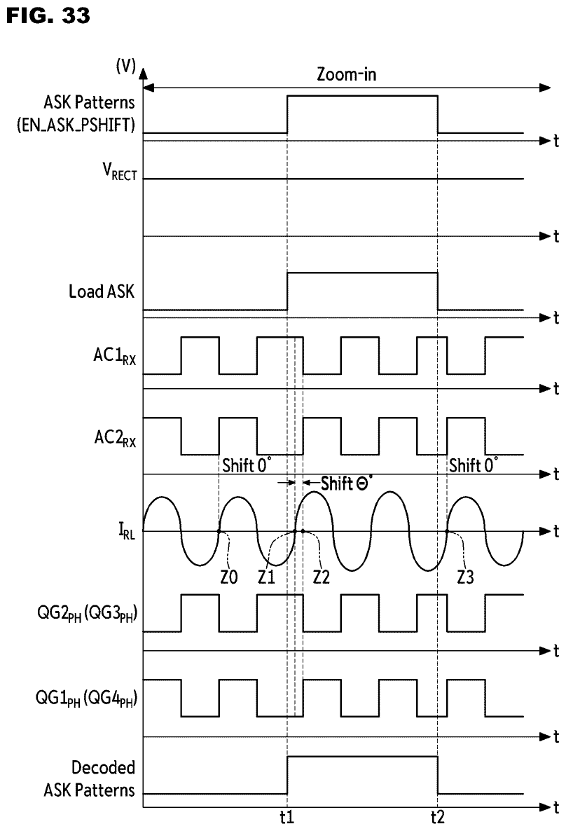

FIG. 33 is a timing diagram for explaining the operation of the wireless power charging transmission system of FIG. 29.

Referring to FIG. 33, when the ASK pattern signal (“ASK Pattern”) is deactivated (or low), the RX device 20 sets the phase difference between the differential RX AC voltage signal (AC2_{RX}−AC1_{RX}) and an RX coil current I_{RL} to zero (e.g., at Z0), and generates rectified gate signals QG1_{PH}, QG2_{PH}, QG3_{PH}, and QG4_{PH} accordingly to perform resistive rectification. In embodiments, the load ASK modulator 310 does not apply the modulation resistor R_{ASK}. Alternatively, in embodiments, the load ASK modulator 310 applies a specific amount of load preset (or alternatively, given) for the deactivation of the ASK pattern signal.

When the ASK pattern signal “ASK Pattern” becomes activated (or high) during a period between t1 and t2, the rectifying synchronization phase-shift controller 100 performs active reactance control to generate the rectified gate signals QG1_{PH}, QG2_{PH}, QG3_{PH}, and QG4_{PH} such that the differential RX AC voltage signal (AC2_{RX}−AC1_{RX}) lags in phase by θ relative to the RX coil current I_{RL} (e.g., during the Z1-Z2 period). In embodiments, the load ASK modulator 310 applies a specific amount of load preset (or alternatively, given) for the activation of the ASK pattern signal “ASK Pattern.” As a result, the load impedance of the RX device 20 is converted into an inductive rectified impedance.

In embodiments, the active reactance control of the rectifying synchronization phase-shift controller 100 may be either control according to a preset (or alternatively, given) θ value to induce a resonance characteristic change, or gradual control toward a preset (or alternatively, given) target rectified voltage V_{RECT_TARGET}.

Then, when the ASK pattern signal “ASK Pattern” is deactivated (or low) again, the rectifying synchronization phase-shift controller 100 generates the rectified gate signals QG1_{PH}, QG2_{PH}, QG3_{PH}, and QG4_{PH} to restore the phase difference between the differential RX AC voltage signal (AC2_{RX}−AC1_{RX}) and the RX coil current I_{RL} to zero (e.g., after Z3). In embodiments, the load ASK modulator 310 does not apply the modulation resistor R_{ASK}, or applies a specific amount of load preset (or alternatively, given) for the deactivation of the ASK pattern signal.

Accordingly, the level of the rectified voltage V_{RECT} may uniformly (or accurately) maintain the ASK pattern signal “ASK Pattern” regardless of a phase shift or lag of 0° or θ°, as determined by the ASK pattern signal.

Being coupled with the RX device 20 in which ASK modulation by a phase lead occurs, the TX device 10 may perform decoding such that a decoded ASK pattern signal “Decoded ASK Pattern” from the TX coil current I_{TX} matches the ASK pattern signal “ASK Pattern” from the RX device 20 (e.g., ASK Pattern=Decoded ASK Pattern).

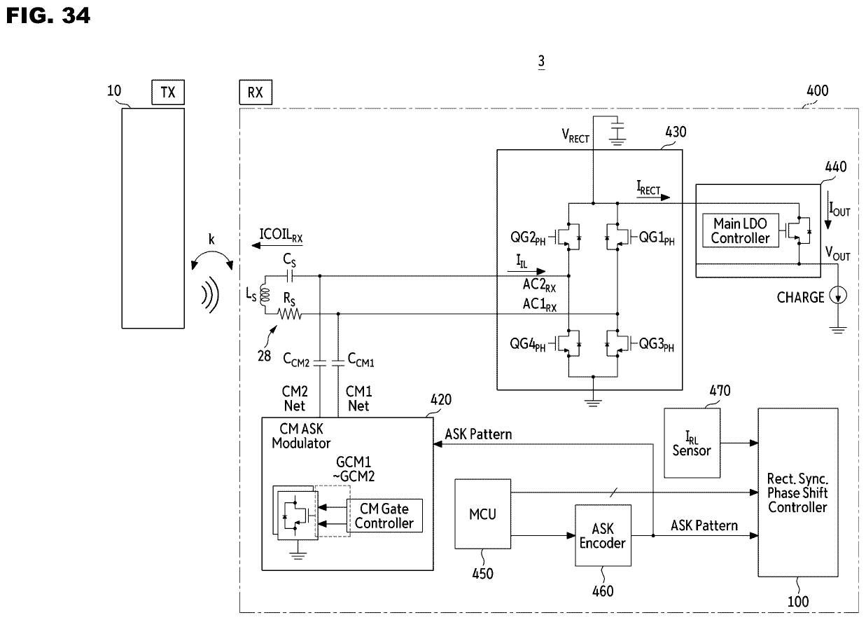

FIG. 34 is a circuit diagram of a wireless power charging system 3 according to embodiments of the present disclosure.

Referring to FIG. 34, the wireless power charging system 3 includes the TX device 10 and an RX device 400 that may use both phase-lag ASK modulation and CM ASK modulation. For example, the RX device 400 may include a CM ASK modulator 420, an RX LC tank 28, a rectifier circuit 430, a main LDO circuit 440, an RX MCU 450, an ASK encoder 460, a coil current sensor 470, a rectifying synchronization phase-shift controller 100, and/or a battery CHARGE. The RX LC tank 28, rectifier circuit 430, main LDO circuit 440, RX MCU 450, ASK encoder 460, coil current sensor 470, rectifying synchronization phase-shift controller 100, and/or battery CHARGE correspond to their respective counterparts in FIG. 1, and thus, redundant descriptions will be omitted.

The CM ASK modulator 420 performs ASK modulation using first and second communication capacitors C_{CM1} and C_{CM2}. Based on an ASK pattern signal “ASK Pattern” received from the ASK encoder 460, the CM ASK modulator 420 connects/disconnects a first CM path “CM1 Net” and a second CM path “CM2 Net” to/from a ground node.

For example, when the ASK pattern signal “ASK Pattern” is high, the CM ASK modulator 420 connects the first and second CM paths “CM1 Net” and “CM2 Net” to the ground node such that the first communication capacitor C_{CM1} is connected between an AC1_{RX} node and the ground node, and the second communication capacitor C_{CM2} is connected between an AC2_{RX} node and the ground node. When the first and second communication capacitors C_{CM1} and C_{CM2} (collectively referred to as external communication capacitors “CM cap”) are connected, the resonance characteristics of the entire wireless power charging system 3 change. This resonance characteristic change leads to amplitude variations in an RX coil current ICOIL_{RX} and the TX coil current ICOIL_{TX}. Additionally, when the ASK pattern signal “ASK Pattern” is high, the rectifying synchronization phase-shift controller 100 generates rectified gate signals QG1_{PH}, QG2_{PH}, QG3_{PH}, and QG4_{PH} based on coil sensing information (V_{ISEN} and I_{ISEN}) and timing delay information (SET_TRISE1, SET_TRISE2, SET_TFALL1, and SET_TFALL2) from the coil current sensor 470. Accordingly, the RX device 400 performs phase-lag or phase-lead ASK modulation in which a differential signal (AC2_{RX}−AC1_{RX}) lags or leads in phase relative to an RX coil current I_{RL} by θ°, while simultaneously (or contemporaneously) performing CM ASK modulation.

When the ASK pattern signal “ASK Pattern” is low, the CM ASK modulator 420 disconnects the first CM paths “CM1 Net” and “CM2 Net” from the ground node. As a result, the first communication capacitor C_{CM1} between the AC1_{RX} and ground nodes is disconnected, and the second communication capacitor C_{CM2} between the AC2_{RX} and ground nodes is also disconnected. When the resonance characteristics of the wireless power charging system 3 return to the original state, the amplitudes of the RX coil current ICOIL_{RX} and TX coil current ICOIL_{TX} vary compared to the state where the external communication capacitors “CM cap” are connected. The rectifying synchronization phase-shift controller 100 generates the rectified gate signals QG1_{PH}, QG2_{PH}, QG3_{PH}, and QG4_{PH} by reflecting coil sensing information (V_{ISEN} and I_{ISEN}) and timing delay information without phase shift, received from the coil current sensor 470. Accordingly, the RX device 400 disables the phase-lag or phase-lead ASK modulation, reverting the phase of the differential RX AC voltage signal (AC2_{RX}−AC1_{RX}) relative to the RX coil current I_{RL} back to its original state, and simultaneously (or contemporaneously) disables the CM ASK modulation.

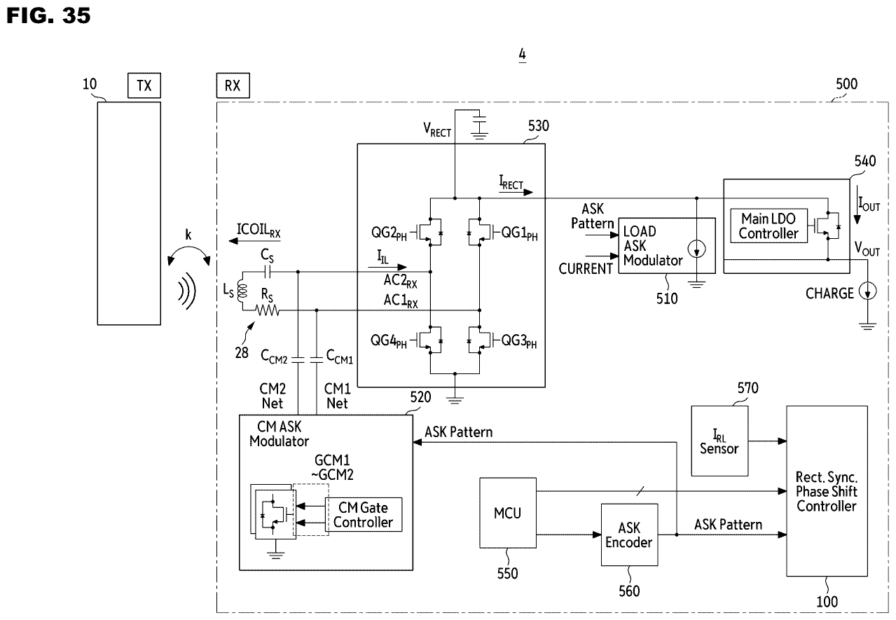

FIG. 35 is a circuit diagram of a wireless power charging system 4 according to embodiments of the present disclosure.

Referring to FIG. 35, the wireless power charging system 4 includes the TX device 10 and an RX device 500 that may use phase-lag ASK modulation, load ASK modulation, and CM ASK modulation together. For example, the RX device 500 may include a load ASK modulator 510, a CM ASK modulator 520, an RX LC tank 28, a rectifier circuit 530, a main LDO circuit 540, an RX MCU 550, an ASK encoder 560, a coil current sensor 570, a rectifying synchronization phase-shift controller 100, and/or a battery CHARGE. The RX LC tank 28, rectifier circuit 530, main LDO circuit 540, RX MCU 550, ASK encoder 560, coil current sensor 570, rectifying synchronization phase-shift controller 100, and battery CHARGE correspond to their respective counterparts in FIG. 29, and thus, redundant descriptions will be omitted.

In embodiments, the RX device 500 may simultaneously (or contemporaneously) perform all the phase-lag ASK modulation, load ASK modulation, and CM ASK modulation according to an ASK pattern signal “ASK Pattern.”

Conventional devices and methods for communicating over a power band with a wireless charger involve modulating a real power load or modulating a reactive power load. Real power load modulation results in static Direct Current (DC) losses, and reactive power load modulation involves additional external capacitors. Accordingly, the conventional devices and methods experience excessive power losses, involve excessive hardware (e.g., manufacturing costs, device dimensions, etc.), and/or are unable to flexibly adjust a depth of Amplitude Shift Keying (ASK).

However, according to embodiments, improved devices and methods are provided for communicating over a power band with a wireless charger. For example, the improved devices and methods involve performing ASK based on a phase shift. Accordingly, the improved devices and methods are able to perform ASK while reducing power losses, reducing hardware (e.g., external capacitors), and/or flexibly adjusting the depth of ASK.

According to embodiments, operations described herein as being performed by the wireless power charging system 1, the TX device 10, the RX device 20, the inverter 12, the TX MCU 15, the ASK decoder 16, the ASK demodulator 17, the inverter controller 13, the LDO circuit 40, the RX MCU 50, the ASK encoder 60, the coil current sensor 70, the rectifying synchronization phase-shift controller 100, the phase value generator 51, the setting value selector 52, the first phase shift delay value generator 53, the second phase shift delay value generator 54, the AND logic circuit 110, the first multiplexer 121, the second multiplexer 122, the rectified gate signal generator 200, the differentiator 221, the integrator 222, each of the plurality of zero-edge detectors 231, 232, and 233, each of the plurality of timing controllers 241, 242, and 243, the gate signal generator 260, the first gate signal generator 260A, the second gate signal generator 260B, the third multiplexer 261, the first gate signal generator 262, the fourth multiplexer 263, the second gate signal generator 264, the TX device 10T, the RX device 20T, the TX device 10F, the RX device 20F, the wireless power charging system 2, the RX device 300, the load ASK modulator 310, the main LDO circuit 340, the RX MCU 350, the ASK encoder 360, the coil current sensor 370, the wireless power charging system 3, the RX device 400, the CM ASK modulator 420, the main LDO circuit 440, the RX MCU 450, the ASK encoder 460, the coil current sensor 470, the wireless power charging system 4, the RX device 500, the load ASK modulator 510, the CM ASK modulator 520, the main LDO circuit 540, the RX MCU 550, the ASK encoder 560, and/or the coil current sensor 570 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items. Other words used to describe the relationship between elements should be interpreted in a like fashion (e.g., “between” versus “directly between,” “adjacent” versus “directly adjacent,” etc.).

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

While embodiments of the present disclosure have been described above with reference to the accompanying drawings, the inventive concepts are not limited to the above-described examples and may be implemented in various different forms. It will be understood by those of ordinary skill in the art to which the inventive concepts pertain that the inventive concepts may be implemented in other specific forms without departing from the spirit or essential features of the inventive concepts. Therefore, the above-described examples should be considered illustrative rather than limiting in every respect.

What is claimed is:

1. A receiver device comprising:
a receiver LC tank including a receiver load capacitor and a receiver coil, the receiver LC tank being configured to receive power induced from a transmitter device;
a coil current sensor configured to sense a receiver coil current based on the power;
a rectifier circuit configured to rectify receiver alternating current (AC) voltages provided from the receiver LC tank into a rectified voltage in response to rectified gate signals; and
processing circuitry configured to,
generate the rectified gate signals by adjusting a phase difference between the receiver coil current and a differential signal between the receiver AC voltages according to a phase shift control signal and an ASK pattern signal, and
output the rectified gate signals to the rectifier circuit.

2. The receiver device of claim 1, wherein the processing circuitry is configured to generate the rectified gate signals based on an ASK enable signal, a gate-signal-control signal, timing delay information, and a selection gate signal.

3. The receiver device of claim 2, wherein the processing circuitry is configured to:
obtain an ASK phase shift control signal based on the ASK pattern signal and the phase shift control signal;
select one of a first rising time delay or a second rising time delay according to the ASK phase shift control signal to obtain selected rising time delay information;
select one of a first falling time delay or a second falling time delay according to the ASK phase shift control signal to obtain selected falling time delay information; and
generate the rectified gate signals based on the selected rising time delay information, the selected falling time delay information, and a coil current sensing voltage.

4. The receiver device of claim 3, wherein the processing circuitry is configured to:
obtain a differentiated signal of the coil current sensing voltage;
detect rising-edge zero points and falling-edge zero points of the differentiated signal;
delay the rising-edge zero points by the selected rising time delay information to obtain delayed rising-edge zero points;
delay the falling-edge zero points by the selected falling time delay information to obtain delayed falling-edge zero points; and
generate the rectified gate signals using the delayed rising-edge zero points and the delayed falling-edge zero points as gate-on and gate-off signals according to the selection gate signal.

5. The receiver device of claim 1, wherein the processing circuitry is configured to perform load ASK modulation by connecting or disconnecting a modulation resistor in parallel with a load resistor of the receiver LC tank according to the ASK pattern signal.

6. The receiver device of claim 1, further comprising:
a first communication capacitor; and
a second communication capacitor,
wherein the processing circuitry configured to,
connect or disconnect the first communication capacitor between a first AC node and a ground node according to the ASK pattern signal, and
connect or disconnect the second communication capacitor between a second AC node and the ground node according to the ASK pattern signal.

7. The receiver device of claim 1, wherein the processing circuitry is configured to generate the rectified gate signals such that the differential signal between the receiver AC voltages lags in phase relative to the receiver coil current during a period in which the ASK pattern signal is activated.

8. The receiver device of claim 1, wherein the processing circuitry is configured to generate the rectified gate signals such that the differential signal between the receiver AC voltages leads in phase relative to the receiver coil current during a period in which the ASK pattern signal is activated.

9. An operating method of a receiver device that receives power wirelessly from a transmitter device, the operating method comprising:
generating coil sensing information by sensing a receiver coil current induced from the transmitter device through a receiver coil;
detecting rising-edge zero points and falling-edge zero points of a signal based on the coil sensing information;
selecting rising time delay information and falling time delay information from among a plurality of pieces of timing delay information based on an ASK pattern signal;
shifting the rising-edge zero points in a first direction by the selected rising time delay information in response to the ASK pattern signal being activated;
shifting the falling-edge zero points in the first direction by the selected falling time delay information in response to the ASK pattern signal being activated;
generating rectified gate signals for a rectifier circuit using the shifted rising-edge zero points and the shifted falling-edge zero points as gate-on/gate-off signals; and
performing amplitude shift keying (ASK) modulation by adjusting a phase difference between the receiver coil current and a differential signal between receiver AC voltages based on the rectified gate signals.

10. The operating method of claim 9, wherein
the shifting of the rising-edge zero points includes shifting the rising-edge zero points backward by the selected rising time delay information in response to the ASK pattern signal being activated; and
the shifting of the falling-edge zero points includes shifting the falling-edge zero points backward by the selected falling time delay information in response to the ASK pattern signal being activated.

11. The operating method of claim 9, wherein
the shifting of the rising-edge zero points includes shifting the rising-edge zero points forward by the selected rising time delay information in response to the ASK pattern signal being activated; and
the shifting of the falling-edge zero points includes shifting the falling-edge zero points forward by the selected falling time delay information in response to the ASK pattern signal being activated.

12. The operating method of claim 9, wherein the transmitter device is configured to:
sense a transmitter coil current induced by the receiver coil current in a transmitter coil,
demodulate an ASK signal from the transmitter coil current, and
generate a decoded ASK pattern signal by decoding the demodulated ASK signal.

13. The operating method of claim 9, wherein the detecting of the rising-edge zero points and the falling-edge zero points comprises detecting rising-edge zero points and falling-edge zero points of any one of a differentiated signal of the coil sensing information, the receiver coil current, or an integrated signal of the coil sensing information.

14. A receiver device comprising:
a coil current sensor configured to sense a current induced from a transmitter device through a receiver coil to obtain coil sensing information;
a rectifier circuit configured to rectify receiver alternating current (AC) voltages generated based on the receiver coil into a rectified voltage in response to rectified gate signals;
processing circuitry configured to,
generate the rectified gate signals based on the coil sensing information and the rectified voltage, and
perform amplitude shift keying (ASK) modulation by adjusting a phase difference between a receiver coil current of the receiver coil and a differential signal between the receiver AC voltages; and
a main low-dropout (LDO) regulator circuit configured to output power with noise removed from the rectified voltage.

15. The receiver device of claim 14, wherein the processing circuitry is configured to disable the ASK modulation based on a phase of the differential signal between the receiver AC voltages being the same as a phase of the receiver coil current.

16. The receiver device of claim 14, wherein the processing circuitry is configured to:
select rising time delay information and falling time delay information from among a plurality of pieces of timing delay information based on whether the ASK modulation is to be performed;
detect rising-edge zero points and falling-edge zero points of a signal based on the coil sensing information;
shift the rising-edge zero points by the selected rising time delay information to obtain shifted rising-edge zero points; and
shift the falling-edge zero points by the selected falling time delay information to obtain shifted falling-edge zero points.

17. The receiver device of claim 16, wherein the processing circuitry is configured to:
generate the rectified gate signals based on the shifted rising-edge zero points and the falling-edge zero points according to a selection gate signal; and
output the rectified gate signals to the rectifier circuit.

18. The receiver device of claim 14, wherein the processing circuitry is configured to cause the differential signal between the receiver AC voltages to lead in phase relative to the receiver coil current during the ASK modulation.

19. The receiver device of claim 14, wherein the processing circuitry is configured to cause the differential signal between the receiver AC voltages to lag in phase relative to the receiver coil current during the ASK modulation.

20. The receiver device of claim 14, wherein the processing circuitry is configured to perform load ASK modulation by connecting and disconnecting a modulation resistor in parallel with a load resistor of a receiver LC tank based on whether the ASK modulation is to be performed.
